(19) United States
(12) Patent Application Publication
(10) Pub. No.: US 2026/0164433 A1
(43) Pub. Date: Jun. 11, 2026

(54) DOWNLINK CONTROL INFORMATION DESIGNS WITH LIGHT ADAPTATION BETWEEN SUBBANDS OF AN ACTIVE BANDWIDTH PART

(71) Applicant: QUALCOMM Incorporated, San Diego, CA (US)

(72) Inventors: Diana MAAMARI, San Diego, CA (US); Gabi SARKIS, San Diego, CA (US); Mostafa KHOSHNEVISAN, San Diego, CA (US)

(21) Appl. No.: 18/977,647

(22) Filed: Dec. 11, 2024

(51) Int. Cl. H04W 72/20; H04W 72/1273; H04W 72/23

(52) U.S. Cl. CPC H04W 72/20; H04W 72/1273; H04W 72/23

(57) ABSTRACT

Methods, systems, and devices for wireless communication are described. Various aspects relate to downlink control information (DCI) designs with light adaptation between subbands of an active bandwidth part (BWP). Some aspects more specifically relate to mechanisms according to which a user equipment (UE) and a network entity may support a decodable DCI across various subbands within an active BWP at the UE. In some examples, the UE may receive first configuration information indicative of a set of parameters associated with an active BWP and, as part of the first configuration information, second configuration information indicative of multiple subbands. Each of the multiple subbands may include a different valid quantity of physical resource blocks (PRBs) and, in some implementations, the UE and the network entity may interpret one or more DCI fields in accordance with a valid quantity of PRBs associated with at least one subband of the multiple subbands.

### FIELD OF TECHNOLOGY

The following relates to wireless communication, including downlink control information designs with light adaptation between subbands of an active bandwidth part (BWP).

### BACKGROUND

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communication systems, a UE may support multiple bandwidth parts (BWPs) and may communicate with a network entity via an active BWP of the multiple BWPs. Each BWP of the multiple BWPs may be associated with a respective set of configured parameters such that, in some cases, the UE may use a first set of configured parameters in accordance with communicating via a first BWP and may use a second set of configured parameters in accordance with communicating via a second BWP. Switching between BWPs may be associated with a corresponding switch between sets of configured parameters, which may involve a relatively “heavy” reconfiguration at the UE.

### SUMMARY

The systems, methods, and devices of this disclosure each have several innovative aspects, no single one of which is solely responsible for the desirable attributes disclosed herein.

One innovative aspect of the subject matter described in this disclosure can be implemented in an apparatus for wireless communication at a user equipment (UE). The apparatus may include a processing system that includes processor circuitry and memory circuitry that stores code. The processing system may be configured to cause the apparatus to receive first configuration information indicative of a set of parameters associated with an active bandwidth part (BWP) of the UE and, as part of the first configuration information, second configuration information indicative of a set of multiple subbands with different valid quantities of physical resource blocks (PRBs), receive a downlink control information (DCI) message that includes a field that indicates, in accordance with an interpretation of the field, a frequency domain resource allocation (FDRA) associated with a data message, a size of the field being independent of the different valid quantities of PRBs of the set of multiple subbands, and the interpretation of the field being in accordance with a valid quantity of PRBs associated with at least one subband of the set of multiple subbands within the active BWP, and communicate the data message in accordance with the FDRA.

Another innovative aspect of the subject matter described in this disclosure can be implemented in a method for wireless communication by or at a UE. The method may include receiving first configuration information indicative of a set of parameters associated with an active BWP of the UE and, as part of the first configuration information, second configuration information indicative of a set of multiple subbands with different valid quantities of PRBs, receiving a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands within the active BWP, and communicating the data message in accordance with the FDRA.

Another innovative aspect of the subject matter described in this disclosure can be implemented in an apparatus for wireless communication at a UE. The apparatus may include means for receiving first configuration information indicative of a set of parameters associated with an active BWP of the UE and, as part of the first configuration information, second configuration information indicative of a set of multiple subbands with different valid quantities of PRBs, means for receiving a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands within the active BWP, and means for communicating the data message in accordance with the FDRA.

Another innovative aspect of the subject matter described in this disclosure can be implemented in a non-transitory computer-readable medium storing code for wireless communication by or at a UE. The code may include instructions executable by a processing system to receive first configuration information indicative of a set of parameters associated with an active BWP of the UE and, as part of the first configuration information, second configuration information indicative of a set of multiple subbands with different valid quantities of PRBs, receive a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands within the active BWP, and communicate the data message in accordance with the FDRA.

In some examples of the method, UEs, apparatuses, and non-transitory computer-readable medium described herein, the set of multiple subbands within the active BWP includes a first subband and a second subband and the first subband includes a first valid quantity of PRBs and the second subband includes a second valid quantity of PRBs that may be greater than the first valid quantity of PRBs.

In some examples of the method, UEs, apparatuses, and non-transitory computer-readable medium described herein, the interpretation of the field may be a first interpretation in accordance with the UE being indicated, by the DCI message or a prior DCI message, to use the first subband that includes the first valid quantity of PRBs; or may be a second interpretation in accordance with the UE being indicated, by the DCI message or the prior DCI message, to use the second subband that includes the second valid quantity of PRBs.

In some examples of the method, UEs, apparatuses, and non-transitory computer-readable medium described herein, the field indicates a resource indication value from a set of resource indication values and the UE or the apparatus expects a subset of resource indication values of the set of resource indication values as valid resource indication values in accordance with the first interpretation and expects the set of resource indication values as the valid resource indication values in accordance with the second interpretation.

In some examples of the method, UEs, apparatuses, and non-transitory computer-readable medium described herein, the field includes a set of bits and the UE or the apparatus uses a subset of bits of the set of bits to obtain the FDRA in accordance with the first interpretation and uses the set of bits to obtain the FDRA in accordance with the second interpretation.

In some examples of the method, UEs, apparatuses, and non-transitory computer-readable medium described herein, the field includes a set of multiple bits and the UE or the apparatus uses the set of multiple bits to obtain the FDRA at a first resource block group (RBG) size in accordance with the first interpretation and uses the set of multiple bits to obtain the FDRA at a second RBG size in accordance with the second interpretation.

Another innovative aspect of the subject matter described in this disclosure can be implemented in an apparatus for wireless communication at a network entity. The apparatus may include a processing system that includes processor circuitry and memory circuitry that stores code. The processing system may be configured to cause the apparatus to output first configuration information indicative of a set of parameters associated with an active BWP of a UE and, as part of the first configuration information, second configuration information indicative of a set of multiple subbands with different valid quantities of PRBs, output a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands within the active BWP, and communicate the data message in accordance with the FDRA.

Another innovative aspect of the subject matter described in this disclosure can be implemented in a method for wireless communication by or at a network entity. The method may include outputting first configuration information indicative of a set of parameters associated with an active BWP of a UE and, as part of the first configuration information, second configuration information indicative of a set of multiple subbands with different valid quantities of PRBs, outputting a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands within the active BWP, and communicating the data message in accordance with the FDRA.

Another innovative aspect of the subject matter described in this disclosure can be implemented in an apparatus for wireless communication at a network entity. The apparatus may include means for outputting first configuration information indicative of a set of parameters associated with an active BWP of a UE and, as part of the first configuration information, second configuration information indicative of a set of multiple subbands with different valid quantities of PRBs, means for outputting a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands within the active BWP, and means for communicating the data message in accordance with the FDRA.

Another innovative aspect of the subject matter described in this disclosure can be implemented in a non-transitory computer-readable medium storing code for wireless communication by or at a network entity. The code may include instructions executable by one or more processors to output first configuration information indicative of a set of parameters associated with an active BWP of a UE and, as part of the first configuration information, second configuration information indicative of a set of multiple subbands with different valid quantities of PRBs, output a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands within the active BWP, and communicate the data message in accordance with the FDRA.

In some examples of the method, network entities, apparatuses, and non-transitory computer-readable medium described herein, the set of multiple subbands within the active BWP includes a first subband and a second subband and the first subband includes a first valid quantity of PRBs and the second subband includes a second valid quantity of PRBs that may be greater than the first valid quantity of PRBs.

In some examples of the method, network entities, apparatuses, and non-transitory computer-readable medium described herein, the interpretation of the field may be a first interpretation in accordance with the network entity indicating, by the DCI message or a prior DCI message, the UE to use the first subband that includes the first valid quantity of PRBs or may be a second interpretation in accordance with the network entity indicating, by the DCI message or the prior DCI message, the UE to use the second subband that includes the second valid quantity of PRBs.

In some examples of the method, network entities, apparatuses, and non-transitory computer-readable medium described herein, the field indicates a resource indication value from a set of resource indication values and the network entity or the apparatus uses a subset of resource indication values of the set of resource indication values as valid resource indication values in accordance with the first interpretation and uses the set of resource indication values as the valid resource indication values in accordance with the second interpretation.

In some examples of the method, network entities, apparatuses, and non-transitory computer-readable medium described herein, the field includes a set of bits and the network entity or the apparatus uses a subset of bits of the set of bits to indicate the FDRA in accordance with the first interpretation and uses the set of bits to indicate the FDRA in accordance with the second interpretation.

In some examples of the method, network entities, apparatuses, and non-transitory computer-readable medium described herein, the field includes a set of multiple bits and the network entity or the apparatus uses the set of multiple bits to indicate the FDRA at a first RBG size in accordance with the first interpretation and uses the set of multiple bits to indicate the FDRA at a second RBG size in accordance with the second interpretation.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system including user equipments (UEs) and network entities that supports downlink control information (DCI) designs with light adaptation between subbands of an active bandwidth part (BWP).

FIG. 2 shows an example of a subband configuration, of multiple subbands within an active BWP, that supports DCI designs with light adaptation between subbands of an active BWP.

FIGS. 3A, 3B, and 4 show examples of communication timelines in which a DCI message schedules a data message in accordance with light adaptation between subbands of an active BWP.

FIG. 5 shows an example of a signaling diagram between a UE and a network entity that supports DCI designs with light adaptation between subbands of an active BWP in accordance with one or more DCI field interpretations at the UE and the network entity.

FIGS. 6A, 6B, 7A, 7B, 8A, and 8B show examples of interpretations, of a field indicative of a frequency domain resource allocation (FDRA), that support DCI designs with light adaptation between subbands of an active BWP.

FIG. 9 shows an example of a process flow illustrative of signaling between a UE and a network entity that supports DCI designs with light adaptation between subbands of an active BWP.

FIGS. 10 and 11 show block diagrams of devices that support DCI designs with light adaptation between subbands of an active BWP.

FIG. 12 shows a block diagram of a communications manager that supports DCI designs with light adaptation between subbands of an active BWP.

FIG. 13 shows a diagram of a system including a device that supports DCI designs with light adaptation between subbands of an active BWP.

FIGS. 14 and 15 show block diagrams of devices that support DCI designs with light adaptation between subbands of an active BWP.

FIG. 16 shows a block diagram of a communications manager that supports DCI designs with light adaptation between subbands of an active BWP.

FIG. 17 shows a diagram of a system including a device that supports DCI designs with light adaptation between subbands of an active BWP.

FIGS. 18 and 19 show flowcharts illustrating methods that support DCI designs with light adaptation between subbands of an active BWP.

### DETAILED DESCRIPTION

In some wireless communication systems, a user equipment (UE) may support multiple bandwidth parts (BWPs) and may communicate with a network entity via an active BWP of the multiple BWPs. Each of the multiple BWPs that a UE supports may be associated with a respective set of configured parameters such that, in some cases, the UE may use a first set of configured parameters in accordance with communicating via a first BWP and may use a second set of configured parameters in accordance with communicating via a second BWP. For example, some parameters may be configured on a per-BWP basis. Switching between BWPs may be associated with a corresponding switch between sets of configured parameters, which may involve a relatively “heavy” reconfiguration at the UE. Such a “heavy” reconfiguration may be associated with a relatively high cost at the UE to store the respective sets of configured parameters for each BWP or a relatively high timeline/reprogramming cost at the UE to reconfigure parameters each time a BWP switch occurs.

To mitigate such reconfiguration costs associated with BWP switches, some systems may support a light bandwidth adaptation mechanism according to which a network entity may configure multiple subbands within a BWP, with the multiple subbands inheriting some of the parameters configured for the BWP and with each of the multiple subbands being configured with relatively smaller sets of subband-specific parameters. In accordance with each of the multiple subbands being configured with relatively smaller sets of subband-specific parameters and otherwise being associated with the same parameters as the larger BWP, switching between subbands may involve a relatively “light” adaptation at a UE. Such a “light” adaptation may be associated with a relatively low cost at the UE to store respective sets of parameters for each subband or a relatively low timeline/reprogramming cost at the UE to reconfigure parameters each time a subband switch occurs. A subband-specific parameter may include bandwidth such that, for example, different subbands may be associated with (may include) different valid quantities of physical resource blocks (PRBs). In some systems, some downlink control information (DCI) fields may be bandwidth dependent (may have different sizes depending on bandwidth), which may cause decodability or complexity issues at a UE that switches between multiple subbands within an active BWP. To increase DCI decodability and reduce complexity associated with DCI messages in systems that support multiple subbands within an active BWP, some systems may benefit from additional DCI field interpretations to support a universal DCI design that is decodable regardless of which subband is currently used by a UE or a network entity.

Various aspects generally relate to DCI designs with light adaptation between subbands of an active BWP. Some aspects more specifically relate to one or more signaling-or configuration-based mechanisms according to which a UE and a network entity may support a decodable DCI across various subbands within an active BWP at the UE. In some examples, the UE may receive first configuration information indicative of a set of parameters associated with an active BWP and, as part of or within the first configuration information, second configuration information indicative of multiple subbands within the active BWP. Each subband of the multiple subbands may be associated with (such as include) a different valid quantity of PRBs and, in some implementations, the UE and the network entity may interpret one or more fields of DCI messages in accordance with a valid quantity of PRBs associated with at least one subband of the multiple subbands. For example, the UE may receive a DCI message that includes a field indicative of an FDRA and may interpret the field in accordance with a valid quantity of PRBs associated with at least one subband. In some examples, the multiple subbands may include a first subband that includes a first valid quantity of PRBs and a second subband that includes a second valid quantity of PRBs. In such examples, the UE may use a first interpretation of the field indicative of the FDRA in accordance with operating at the first subband and may use a second interpretation of the field indicative of the FDRA in accordance with operating at the second subband.

Particular aspects of the subject matter of the present disclosure may be implemented to realize one or more of the following advantages. For example, by supporting different interpretations of a field indicative of an FDRA within DCI messages, a UE and a network entity may use a same size for the field indicative of the FDRA across various subbands within an active BWP, which may support use of a same DCI design across the various subbands within the active BWP and increase a decodability of the DCI messages. By increasing the decodability of the DCI messages, the UE and the network entity may experience more reliable communications and higher data rates by way of such more reliable communications. Additionally, the UE and the network entity may experience greater spectral efficiency and greater system capacity, among other benefits, by increasing the decodability of the DCI messages. Moreover, by supporting a same DCI design (such as a universal DCI design) across the various subbands within the active BWP, the UE and the network entity may achieve lower processing costs and fewer decoding attempts by expecting same DCI field sizes regardless of which subband the UE and the network entity are operating at within the active BWP. Further, by increasing the decodability of the DCI messages, more systems may support light adaptation between subbands of an active BWP, which may reduce power consumption, reduce device complexity, and facilitate lower latency bandwidth switches by facilitating an adaptation of select (and relatively few) parameters on a per-subband basis and maintaining other parameters across subbands.

Aspects of the disclosure are initially described in the context of wireless communications systems. Additionally, aspects of the disclosure are illustrated by and described with reference to a subband configuration, communication timelines, a signaling diagram, field interpretations, and a process flow. Aspects of the disclosure are further illustrated by and described with reference to apparatus diagrams, system diagrams, and flowcharts that relate to DCI designs with light adaptation between subbands of an active BWP.

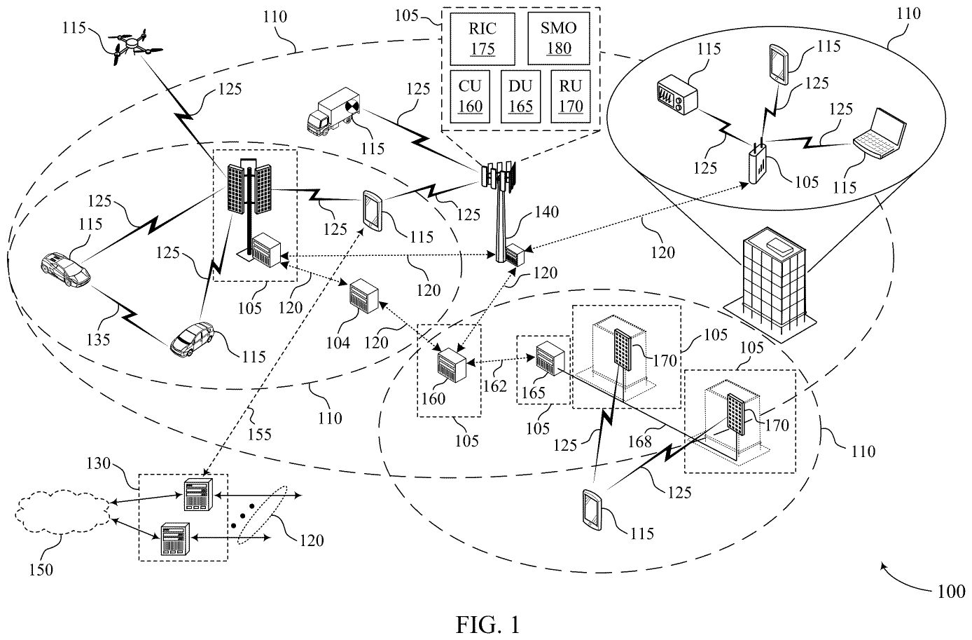

FIG. 1 shows an example of a wireless communications system 100 including UEs 115 and network entities 105 that supports downlink control information designs with light adaptation between subbands of an active bandwidth part. The wireless communications system 100 may include one or more devices, such as one or more network devices (such as network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (such as a radio frequency (RF) access link). For example, a network entity 105 may support a coverage area 110 (such as a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (such as other wireless communication devices, including UEs 115 or network entities 105), as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (such as in accordance with an S1, N2, N3, or other interface protocol). In some examples, network entities 105 may communicate with one another via backhaul communication link(s) 120 (such as in accordance with an X2, Xn, or other interface protocol) either directly (such as directly between network entities 105) or indirectly (such as via the core network 130). In some examples, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication link(s) 120, midhaul communication links 162, or fronthaul communication links 168 may be or include one or more wired links (such as an electrical link, an optical fiber link) or one or more wireless links (such as a radio link, a wireless optical link), among other examples or various combinations thereof. A UE 115 may communicate with the core network 130 via a communication link 155.

One or more of the network entities 105 or network equipment described herein may include or may be referred to as a base station 140 (such as a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (such as a base station 140) may be implemented in an aggregated (such as monolithic, standalone) base station architecture, which may be configured to utilize a protocol stack that is physically or logically integrated within one network entity (such as a network entity 105 or a single RAN node, such as a base station 140).

In some examples, a network entity 105 may be implemented in a disaggregated architecture (such as a disaggregated base station architecture, a disaggregated RAN architecture), which may be configured to utilize a protocol stack that is physically or logically distributed among multiple network entities (such as network entities 105), such as an integrated access and backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (such as a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some examples, one or more of the network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending on which functions (such as network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (such as layer 3(L3 ), layer 2 (L2)) functionality and signaling (such as Radio Resource Control (RRC), service data adaptation protocol (SDAP), Packet Data Convergence Protocol (PDCP)). The CU 160 (such as one or more CUs) may be connected to a DU 165 (such as one or more DUs) or an RU 170 (such as one or more RUs), or some combination thereof, and the DUs 165, RUs 170, or both may host lower protocol layers, such as layer 1(L 1 ) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or multiple different RUs, such as an RU 170). In some cases, a functional split between a CU 160 and a DU 165 or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (such as F1, F1-c, F1-u), and a DU 165 may be connected to an RU 170 via a fronthaul communication link 168 (such as open fronthaul (FH) interface). In some examples, a midhaul communication link 162 or a fronthaul communication link 168 may be implemented in accordance with an interface (such as a channel) between layers of a protocol stack supported by respective network entities (such as one or more of the network entities 105) that are in communication via such communication links.

In some wireless communications systems (such as the wireless communications system 100), infrastructure and spectral resources for radio access may support wireless backhaul link capabilities to supplement wired backhaul connections, providing an IAB network architecture (such as to a core network 130). In some cases, in an IAB network, one or more of the network entities 105 (such as network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (such as IAB donors) may be in communication with one or more additional devices (such as IAB node(s) 104) via supported access and backhaul links (such as backhaul communication link(s) 120). IAB node(s) 104 may include an IAB mobile termination (IAB-MT) controlled (such as scheduled) by one or more DUs (such as DUs 165) of a coupled IAB donor. An IAB-MT may be equipped with an independent set of antennas for relay of communications with UEs 115 or may share the same antennas (such as of an RU 170) of IAB node(s) 104 used for access via the DU 165 of the IAB node(s) 104 (such as referred to as virtual IAB-MT (vIAB-MT)). In some examples, the IAB node(s) 104 may include one or more DUs (such as DUs 165) that support communication links with additional entities (such as IAB node(s) 104, UEs 115) within the relay chain or configuration of the access network (such as downstream). In such cases, one or more components of the disaggregated RAN architecture (such as the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support downlink control information designs with light adaptation between subbands of an active bandwidth part as described herein. For example, some operations described as being performed by a UE 115 or a network entity 105 (such as a base station 140) may additionally, or alternatively, be performed by one or more components of the disaggregated RAN architecture (such as components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (such as one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (such as a bandwidth part (BWP)) that is operated according to one or more PHY layer channels for a given RAT (such as LTE, LTE-A, LTE-A Pro, NR). Each PHY layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a base station 140, a CU 160, a DU 165, a RU 170) of a RAN communicating with another device (such as directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (such as an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (such as of the same or a different RAT).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (such as 1.4, 3, 5, 10, 15, 20, 40, or 80 megahertz (MHz)). Devices of the wireless communications system 100 (such as the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (such as a subband, a BWP) or all of a carrier bandwidth.

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, in which case the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively-numbered subframes or slots, and each subframe or slot may have the same duration. In some examples, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (such as N_{ƒ}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some examples, the TTI duration (such as a quantity of symbol periods in a TTI) may be variable. Additionally, or alternatively, the smallest scheduling unit of the wireless communications system 100 may be dynamically selected (such as in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to UEs 115 (such as one or more UEs) or may include UE-specific search space sets for sending control information to a UE 115 (such as a specific UE).

In some examples, a network entity 105 (such as a base station 140, an RU 170) may be movable and therefore provide communication coverage for a moving coverage area, such as the coverage area 110. In some examples, coverage areas 110 (such as different coverage areas) associated with different technologies may overlap, but the coverage areas 110 (such as different coverage areas) may be supported by the same network entity (such as a network entity 105). In some other examples, overlapping coverage areas, such as a coverage area 110, associated with different technologies may be supported by different network entities (such as the network entities 105). The wireless communications system 100 may include, for example, a heterogeneous network in which different types of the network entities 105 support communications for coverage areas 110 (such as different coverage areas) using the same or different RATs.

Some UEs 115 may be configured to employ operating modes that reduce power consumption, such as half-duplex communications (such as a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (such as according to narrowband communications), or a combination of these techniques. For example, some UEs 115 may be configured for operation using a narrowband protocol type that is associated with a defined portion or range (such as set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (such as one or more of the UEs 115) via a device-to-device (D2D) communication link, such as a D2D communication link 135 (such as in accordance with a peer-to-peer (P2P), D2D, or sidelink protocol). In some examples, one or more UEs 115 of a group that are performing D2D communications may be within the coverage area 110 of a network entity 105 (such as a base station 140, an RU 170), which may support aspects of such D2D communications being configured by (such as scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (such as less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (such as the communication link(s) 125, a D2D communication link 135). HARQ may include a combination of error detection (such as using a cyclic redundancy check (CRC)), forward error correction (FEC), and retransmission (such as automatic repeat request (ARQ)). HARQ may improve throughput at the MAC layer in relatively poor radio conditions (such as low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may support multiple BWPs and may communicate with a network entity 105 via an active BWP of the multiple BWPs. Such multiple BWPs may include up to four uplink BWPs and up to four downlink BWPs, although UEs 115 described herein may support any quantity of uplink or downlink BWPs. For example, a UE may support any quantity of BWPs for communication via one or more uplink channels and may support any quantity of BWPs for communication via one or more downlink channels. Uplink channels may include a physical uplink shared channel (PUSCH), a physical uplink control channel (PUCCH), and a physical random access channel (PRACH). Downlink channels may include a physical downlink shared channel (PDSCH) and a physical downlink control channel (PDCCH). Thus, supporting and switching between different BWPs may enable a UE 115 to experience flexible spectrum assignment different from a carrier bandwidth. A UE 115 may support a single active BWP, such that the UE 115 may use one BWP as an active BWP at a time. Each of the multiple BWPs that a UE 115 supports may be associated with a respective set of configured parameters such that, in some cases, the UE 115 may use a first set of configured parameters in accordance with communicating via a first BWP and may use a second set of configured parameters in accordance with communicating via a second BWP.

For example, parameters associated with one or more of a bandwidth (such as 20 MHz or 100 MHz, among other examples), a subcarrier spacing (SCS), a modulation and coding scheme (MCS) table, a channel state information (CSI) configuration, a maximum rank, a control resource set (CORESET), a sounding reference signal (SRS) configuration, a configured grant (CG) configuration, semi-persistently scheduled communications, beam failure reporting parameters, and radio link management (RLM) parameters may be configured on a per-BWP basis. Such parameters may be examples of RRC parameters, which may be organized in a BWP container (such that, in some aspects, BWPs may be understood as profiles). Use of BWPs may enable adaptation of radio (such as RRC) parameters at a UE 115. A BWP change may occur via RRC or DCI signaling or in accordance with an expiry of a BWP inactive timer. A change in a BWP may be associated with a change in a monitored bandwidth, such as a change from 20 MHz to 100 MHz for a time period within which a relatively large amount of data is to be transmitted to a UE 115.

Switching between BWPs may be associated with a corresponding switch between sets of configured parameters, which may involve a relatively “heavy” reconfiguration at a UE 115. For example, issues may arise in some deployment scenarios because of a relatively large quantity of configurations that are BWP-dependent. Such a “heavy” reconfiguration may be associated with a relatively high cost at the UE 115 to store the respective sets of configured parameters for each BWP or a relatively high timeline/reprogramming cost at the UE 115 to reconfigure parameters each time a BWP switch occurs. Thus, while supporting configurations on a per-BWP basis may provide relatively greater system flexibility, having a relatively large quantity of configurations that are BWP-dependent may incur some costs in terms of complexity at a UE 115.

For example, from a perspective of a UE 115, the UE 115 may either pay a relatively higher area cost to store a complete set of configurations (such as for a complete set of BWPs) or pay a timeline cost to a reprogramming cost each time the UE 115 switches from one BWP to another BWP. A significant portion of a time delay associated with BWP switching may be spent reconfiguring the UE 115 with a set of parameters associated with the BWP to which the UE 115 is switching. Such reconfiguration may include both hardware and firmware reconfiguration. Further, with BWP there may be a risk of a UE 115 being unreachable for a duration at times when the UE 115 moves to a wider BWP while a network entity 105 remains in a narrow BWP, or vice versa. A UE 115 may be unable to receive signaling (such as a DCI message) from a network entity 105 for such durations.

To mitigate such reconfiguration costs associated with BWP switches, some systems may support a light bandwidth adaptation mechanism according to which a network entity 105 may configure multiple subbands within a BWP, with the multiple subbands inheriting some of the parameters configured for the BWP and with each of the multiple subbands being configured with relatively smaller sets of unique parameters. For example, a UE 115 may receive first configuration information indicative of a set of parameters associated with a BWP and, as part of or within the first configuration information, second configuration information indicative of multiple subbands within the BWP. A unique parameter between the multiple subbands may include bandwidth such that, for example, a first subband may be associated with a first valid quantity of PRBs and a second subband may be associated with a second valid quantity of PRBs. A valid quantity of PRBs may correspond to or otherwise be understood as a quantity of PRBs that is usable for scheduling communications between a UE 115 and a network entity 105. In accordance with such a light bandwidth adaptation mechanism, a set of baseband configurations may remain the same across the multiple subbands within an active BWP, leading to an avoidance of a “heavy” reconfiguration at a UE 115 when the UE 115 switches between subbands.

In accordance with each of the multiple subbands being configured with relatively smaller sets of unique parameters and otherwise being associated with the same parameters as the BWP, switching between subbands may involve a relatively “light” adaptation at a UE 115. Such a “light” adaptation may be associated with a relatively low cost at the UE 115 to store respective sets of parameters for each subband or a relatively low timeline/reprogramming cost at the UE 115 to reconfigure parameters each time a subband switch occurs. For example, in accordance with switching between subbands within an active BWP (such as adapting the bandwidth in accordance with the configuration of subbands and subband identifiers (IDs) within the active BWP), the UE 115 may reconfigure a relatively smaller quantity of parameters as compared to how many parameters the UE 115 may reconfigure in accordance with switching between BWPs, which may result in less down time per UE 115 and reduce penalties associated with a misalignment between a UE 115 and a network entity 105.

In some implementations, a UE 115 and a network entity 105 may support one or more signaling- or configuration-based mechanisms according to which the UE 115 and the network entity 105 are able to use a universal DCI design across various subbands within an active BWP (such as regardless of at which subband the UE 115 or the network entity 105 operates). In such implementations, the UE 115 and the network entity 105 may use or expect a size of one or more fields within a DCI message that is independent of the different valid quantities of PRBs of the multiple subbands within the active BWP. For example, a DCI message may include a field indicative of an FDRA (such as an FDRA or resource indication value (RIV) field) and, instead of a size of the field being dependent on a quantity of valid PRBs associated with a subband at which the network entity 105 operates, the size of the field may be the same across the multiple subbands within the active BWP. In other words, a DCI design (across one or multiple DCI formats) may remain according to a size and configuration of the active BWP).

In accordance with maintaining a same size for the field indicative of the FDRA across the multiple subbands within the active BWP, the UE 115 and the network entity 105 may support different interpretations of the field dependent on at which subband the UE 115 and the network entity 105 operate. For example, the UE 115 and the network entity 105 may use a first interpretation of the field indicative of the FDRA in accordance with operating at the first subband (associated with the first valid quantity of PRBs) and may use a second interpretation of the field indicative of the FDRA in accordance with operating at the second subband (associated with the second valid quantity of PRBs). By supporting different interpretations depending on at which subband the UE 115 and the network entity 105 operate, the UE 115 and the network entity 105 may facilitate greater DCI decodability and lower device complexity, which may increase a reliability of communications and reduce device power consumption.

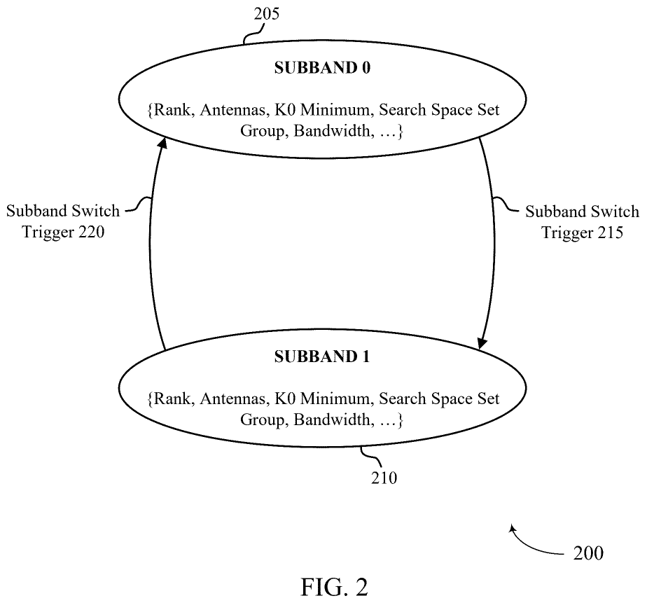

FIG. 2 shows an example of a subband configuration 200, of multiple subbands within an active BWP, that supports DCI designs with light adaptation between subbands of an active BWP. The subband configuration 200 may implement or be implemented to realize or facilitate one or more aspects of the wireless communications system 100. For example, the subband configuration 200 may define a first subband 205 (illustrated in the example of FIG. 2 as a “subband 0”) and a second subband 210 (illustrated in the example of FIG. 2 as a “subband 1”). For example, a UE 115 and a network entity 105, such as a UE 115 and a network entity 105 as illustrated by and described with reference to FIG. 1, may support the subband configuration 200 to realize or facilitate one or more aspects of the present disclosure.

The first subband 205 and the second subband 210 may be associated with a set of parameters that is also associated with a BWP that includes the first subband 205 and the second subband 210. Additionally, in some examples, the first subband 205 and the second subband 210 may be associated with unique (and smaller) sets of parameters that are subband-specific. Such smaller sets of parameters that are subband-specific may include one or more of a (maximum) rank, a quantity of operated antennas (such as a quantity of active receive (Rx) or transmit (Tx) antennas), timeline parameters (such as a K0 minimum, which may be understood as a minimum scheduling offset), a search space set group (such as a search space periodicity, such as to replace search space set group switching without a possibility of changing CORESET), and a bandwidth, among other examples. For example, the first subband 205 may be associated with one or more of a first (maximum) rank, a first quantity of operated antennas, a first K0 minimum, a first search space set group, and a first bandwidth (such as a first valid quantity of PRBs). By way of further example, the second subband 210 may be associated with one or more of a second (maximum) rank, a second quantity of operated antennas, a second K0 minimum, a second search space set group, and a second bandwidth (such as a second valid quantity of PRBs).

In some aspects, the first subband 205 (which may be equivalently referred to herein as a first bandwidth or a first sub-BWP of a BWP) may be associated with a first communication configuration (such as a first state or mode) and the second subband 210 (which may be equivalently referred to herein as a second bandwidth or a second sub-BWP of a BWP) may be associated with a second communication configuration (such as a second state or mode). The first communication configuration may be associated with, indicate, define, or specify a first maximum bandwidth, a first minimum processing timeline, a first minimum scheduling offset, and/or a first maximum rank. The second communication configuration may be associated with, indicate, define, or specify a second maximum bandwidth, a second minimum processing timeline, a second minimum scheduling offset, and/or a second maximum rank. In examples in which the first subband 205 includes a relatively smaller valid quantity of PRBs as compared to the second subband 210, the first maximum bandwidth may be smaller than the second maximum bandwidth, the first minimum processing timeline may be longer than the second minimum processing timeline, the first minimum scheduling offset may be longer than the second minimum scheduling offset, or the first maximum rank may be relatively smaller than the second maximum rank. In some implementations, the UE 115 may switch between operation in accordance with the first communication configuration and the second communication configuration more quickly than switching between BWPs.

The UE 115 and the network entity 105 may support a subband switch trigger 215 to switch from the first subband 205 to the second subband 210 and may support a subband switch trigger 220 to switch from the second subband 210 to the first subband 205. Such switching triggers may be one or more of DCI-based, timer-based, or event-based, among other examples. In some aspects, subband switching may be accompanied with a scheduling delay, such that K0/K2 is greater than 0. Same slot scheduling may be possible according to active adaptation parameters (such as adaptation between subband-specific parameters).

In some implementations, a DCI message may remain unchanged through adaptation between different subbands within an active BWP. In such implementations, the UE 115 may still be able to decode DCI messages even in scenarios in which the UE 115 and the network entity 105 are misaligned (such as out of synchronization) regarding at which subband to operate. Further, in such implementations, unchanged DCI messages through adaptation between different subbands may reduce an amount of reprogramming that the UE 115 performs to reconcile a misalignment or lack of synchronization regarding at which subband to operate.

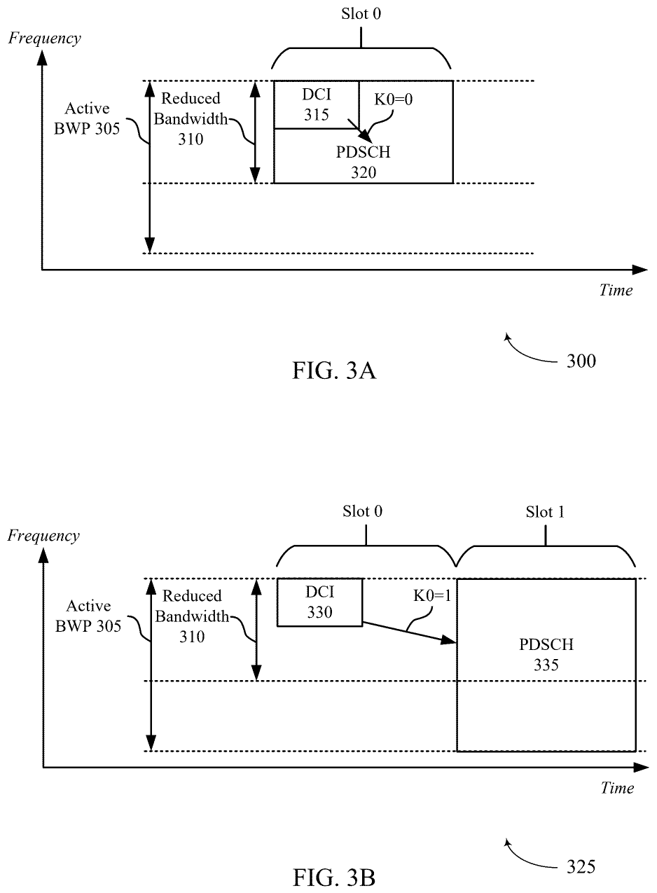

FIGS. 3A and 3B shows examples of a communication timeline 300 and a communication timeline 325, respectively, in which a DCI message schedules a data message in accordance with light adaptation between subbands of an active BWP. The communication timeline 300 and the communication timeline 325 may implement or be implemented to realize or facilitate one or more aspects of the wireless communications system 100 or the subband configuration 200. For example, a UE 115 and a network entity 105, which may be examples of corresponding devices described herein, may communicate in accordance with one or both of the communication timeline 300 and the communication timeline 325.

For example, the UE 115 and the network entity 105 may communicate via an active BWP 305. In some implementations, the UE 115 and the network entity 105 may support multiple subbands within the active BWP 305. In such implementations, a first subband (such as the first subband 205) may be associated with a first bandwidth (such as a first valid quantity of PRBs) and a second subband (such as the second subband 210) may be associated with a second bandwidth (such as a second valid quantity of PRBs). In some examples, the first bandwidth may be a reduced bandwidth 310 and the second bandwidth may be a full bandwidth of the active BWP 305. In such examples, the first subband may be a subset of the second subband. In other words, the first valid quantity of PRBs may be a subset of the second valid quantity of PRBs. The full bandwidth of the active BWP 305 may be understood or referred to as a carrier bandwidth.

In accordance with the communication timeline 300, the UE 115 may receive, from the network entity 105, a DCI message 315 that includes scheduling information associated with a data message (such as a downlink data message) to be communicated via a PDSCH 320. The DCI message 315 may indicate a slot offset (such as a scheduling offset) of K0=0, which may schedule the data message (such as the PDSCH 320) for a same slot within which the UE 115 receives the DCI message 315. In accordance with the example of the communication timeline 300, the UE 115 and the network entity 105 may operate at the first subband (such as the reduced bandwidth 310).

The first subband (such as the reduced bandwidth 310) may be associated with a scheduling restriction. For example, the UE 115 or the network entity 105 may use a scheduling restriction to adapt operation (such as to adapt bandwidth). By way of further example, a scheduled PDSCH or PUSCH that exceeds the reduced bandwidth 310 may be considered as an invalid grant in accordance with the UE 115 or the network entity 105 operating at the first subband. In some aspects, such a scheduling restriction may be timing-based such that, for example, the UE 115 or the network entity 105 may not expect the DCI message 315 to schedule a data message with an FDRA that exceeds the reduced bandwidth 310 within a threshold duration (such as a threshold K0 value, which may be a K0 value of 0) of the DCI message 315. If the data message is scheduled past the threshold duration (such as with a K0 value of 1 or greater), the UE 115 or the network entity 105 may allow the DCI message 315 to schedule a data message with an FDRA that exceeds the reduced bandwidth 310.

In accordance with the communication timeline 325, the UE 115 may receive, from the network entity 105, a DCI message 330 that includes scheduling information associated with a data message (such as a downlink data message) to be communicated via a PDSCH 335. The DCI message 330 may indicate a slot offset (such as a scheduling offset) of K0=1, which may schedule the data message (such as the PDSCH 335) for a next slot after the slot within which the UE 115 receives the DCI message 330. In accordance with the example of the communication timeline 325, the UE 115 and the network entity 105 may operate at the second subband (such as the full bandwidth of the active BWP 305), at least for communication (such as transmission or reception) of the data message.

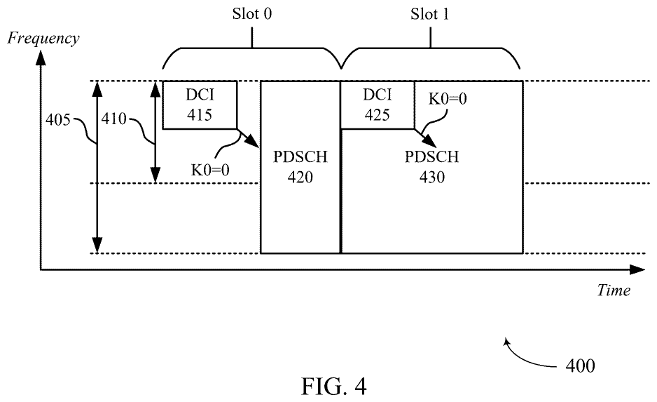

FIG. 4 shows an example of a communication timeline 400 in which a DCI message schedules a data message in accordance with light adaptation between subbands of an active BWP. The communication timeline 400 may implement or be implemented to realize or facilitate one or more aspects of the wireless communications system 100, the subband configuration 200, the communication timeline 300, or the communication timeline 325. For example, a UE 115 and a network entity 105, which may be examples of corresponding devices described herein, may communicate in accordance with the communication timeline 400.

For example, the UE 115 and the network entity 105 may communicate via an active BWP 405. In some implementations, the UE 115 and the network entity 105 may support multiple subbands within the active BWP 405. In such implementations, a first subband (such as the first subband 205) may be associated with a first bandwidth (such as a first valid quantity of PRBs) and a second subband (such as the second subband 210) may be associated with a second bandwidth (such as a second valid quantity of PRBs). In some examples, the first bandwidth may be a reduced bandwidth 410 and the second bandwidth may be a full bandwidth of the active BWP 405. In such examples, the first subband may be a subset of the second subband. In other words, the first valid quantity of PRBs may be a subset of the second valid quantity of PRBs. The full bandwidth of the active BWP 405 may be understood or referred to as a carrier bandwidth.

In accordance with the communication timeline 400, the UE 115 may receive, from the network entity 105, a DCI message 415 that includes scheduling information associated with a data message (such as a downlink data message) to be communicated via a PDSCH 420. The DCI message 415 may indicate a slot offset (such as a scheduling offset) of K0=0, which may schedule the data message (such as the PDSCH 420) for a same slot within which the UE 115 receives the DCI message 415. Additionally, the UE 115 may receive, from the network entity 105, a DCI message 425 that includes scheduling information associated with a data message (such as a downlink data message) to be communicated via a PDSCH 430. The DCI message 425 may indicate a slot offset (such as a scheduling offset) of K0=0, which may schedule the data message (such as the PDSCH 430) for a same slot within which the UE 115 receives the DCI message 425. In accordance with the example of the communication timeline 400, the UE 115 and the network entity 105 may operate at the second subband (such as the full bandwidth of the active BWP 405).

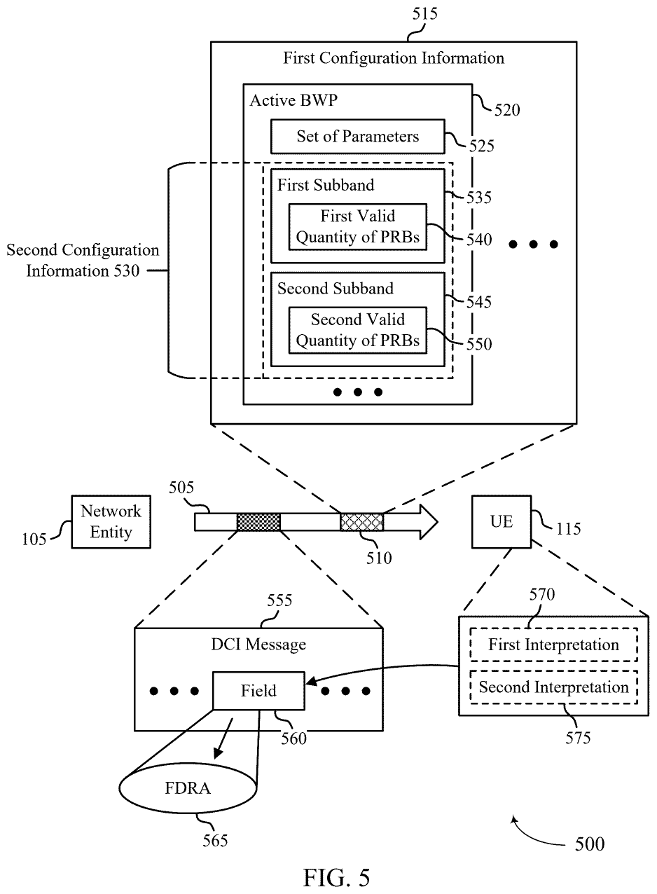

FIG. 5 shows an example of a signaling diagram 500 between a UE 115 and a network entity 105 that supports DCI designs with light adaptation between subbands of an active BWP in accordance with one or more DCI field interpretations at the UE 115 and the network entity 105. The signaling diagram 500 may implement or be implemented to realize or facilitate one or more aspects of the wireless communications system 100, the subband configuration 200, the communication timeline 300, the communication timeline 325, or the communication timeline 400. The UE 115 and the network entity 105, which may be examples of corresponding devices described herein, may communicate via a communication link 505 (such as a downlink).

In some implementations, the UE 115 may receive control signaling 510 from the network entity 105 indicative of configuration information. Such control signaling 510 may include RRC signaling, one or more MAC control elements (MAC-CEs), one or more DCI messages, or any combination thereof. The signaling 510 may configure the UE 115 with one or more parameters associated with one or more BWPs and one or more subbands within each BWP. For example, the signaling 510 may indicate first configuration information 515 indicative of a set of parameters 525 associated with an active BWP 520 (such as a configured BWP that is used as an active BWP) and, as part of the first configuration information 515, second configuration information 530 indicative of a first subband 535 and a second subband 545 within the active BWP 520. The signaling 510 may indicate, configure, or define one or more other BWPs in addition to the active BWP 520 (including one or both of uplink BWPs and downlink BWPs) and may indicate, configure, or define whether a BWP includes multiple subbands on a per-BWP basis.

The set of parameters 525 may include any one or more parameters that are configured as being associated with the active BWP 520 and, in some aspects, may be inherited by or common to (such as universally applicable to) the first subband 535 and the second subband 545. For example, the set of parameters 525 may include one or more parameters associated with a BWP bandwidth (such as 20 MHz or 100 MHz, among other examples), one or more parameters associated with an SCS, one or more parameters associated with an MCS table, one or more parameters associated with a CSI configuration, one or more parameters associated with a maximum rank, one or more parameters associated with a CORESET, one or more parameters associated with an SRS configuration, one or more parameters associated with a CG configuration, one or more parameters associated with semi-persistently scheduled communications, one or more parameters associated with beam failure reporting, one or more parameters associated with RLM, or any combination thereof, among other examples of BWP-specific parameters. In some aspects, the set of parameters 525 may include one or more baseband parameters, such that configurations to baseband remain the same between subbands of the active BWP 520. Such baseband parameters may include CORESET and DCI size configurations. In accordance with maintaining same baseband configurations across the subbands within the active BWP 520, the UE 115 may be reachable (by way of decodable DCI) regardless of at which subband the UE 115 operates (even in scenarios in which there is a subband mismatch between the UE 115 and the network entity 105).

The second configuration information 530 may indicate (such as define or configure) subbands within the active BWP 520 and provide a subband ID to each subband within the active BWP 520. For example, the second configuration information 530 may indicate an ID of 0 for the first subband 535 and may indicate an ID of 1 for the second subband 545. Subsequent signaling (such as one or more DCI messages) between the UE 115 and the network entity 105 may refer to the first subband 535 or the second subband 545 by subband ID. For example, a DCI message may include a field indicative of a subband ID (such as via which a scheduled data message is to be transmitted), which may increase a size of the DCI message as compared to DCI messages in systems unsupportive of multiple subbands within an active BWP.

In some implementations, the second configuration information 530 may indicate that the first subband 535 includes or is otherwise associated with a first valid quantity of PRBs 540 and that the second subband 545 includes or is otherwise associated with a second valid quantity of PRBs 550, among one or more other subband-specific parameters. In some examples, the first subband 535 (such as the first subband 205) may be associated with a relatively restricted or narrow bandwidth and the second subband 545 (such as the second subband 210) may be associated with a relatively wide bandwidth. In such examples in which the first subband 535 is relatively narrower as compared to the second subband 545, the second valid quantity of PRBs 550 may be greater than the first valid quantity of PRBs 540. For example, the first valid quantity of PRBs 540 may be a subset of the second valid quantity of PRBs 550 (such that the first subband 535 may likewise be a subset of the second subband 545).

In some implementations, the UE 115 and the network entity 105 may support one or more signaling-or configuration-based mechanisms according to which the UE 115 and the network entity 105 may interpret one or more DCI fields in accordance with subbands within the active BWP 520 including or otherwise being associated with different valid quantities of PRBs. For example, the UE 115 and the network entity 105 may support an interpretation of one or more DCI fields that depends on (such as varies with or is based on) a valid quantity of PRBs of at least one subband within the active BWP 520. In some aspects, the interpretation may vary in accordance with at least one subband within the active BWP 520 being associated with a relatively smaller quantity of valid PRBs as compared to one or more other subbands within the active BWP 520, as such a subband may be associated with a scheduling restriction or a different bandwidth as compared to the one or more other subbands. Thus, in some implementations, the UE 115 and the network entity 105 may support and use same DCI field sizes (such as a universal DCI) that is decodable across the subbands within the active BWP 520, such that DCI field sizes are invariable across different subbands (including across different subbands of different bandwidths). In other words, instead of some DCI field sizes being bandwidth dependent, such DCI field sizes may be independent of the different valid quantities of PRBs of the subbands within the active BWP 520 (such as independent of whether the UE 115 is scheduled with or without a scheduling restriction).

For example, the UE 115 may receive, from the network entity 105, a DCI message 555 that includes scheduling information associated with a data message. Such scheduling information may include a time domain resource assignment (such as a slot offset), an FDRA, a subband ID, or a redundancy version, among other examples. For example, the DCI message 555 may be a scheduling DCI that schedules the data message. The DCI message 555 may include a field 560 indicative of an FDRA 565 (such as an FDRA or RIV field) and, in some implementations, a size of the field 560 may be independent of the different quantities of PRBs of the subbands within the active BWP 520. In accordance with the field 560 having a size that is independent of (such as the same across) the subbands within the active BWP 520, the UE 115 and the network entity 105 may support one or more interpretations of the field 560 in accordance with at which subband the UE 115 and the network entity 105 operate.

For example, the UE 115 (and the network entity 105) may use a first interpretation 570 of the field 560 in accordance with operating at the first subband 535 and may use a second interpretation 575 of the field 560 in accordance with operating at the second subband 545. In such examples, the field 560 may indicate the FDRA 565 in accordance with the first interpretation 570 in accordance with operation at the first subband 535 and may indicate the FDRA 565 in accordance with the second interpretation 575 in accordance with operation at the second subband 545. By maintaining a same size and design of the field 560 (such as a same encoding of the field 560) for the multiple subbands within the active BWP 520, the design of the DCI message 555 may be independent of subband bandwidth and the DCI message 555 may remain decodable regardless of via which subband the UE 115 receives the DCI message 555. In some aspects, a size of the field 560 may be associated with a largest (such as widest) subband of the multiple subbands within the active BWP 520. By supporting multiple interpretations of the field 560, the UE 115 and the network entity 105 may reduce DCI complexity, such as the complexity associated with decoding or generating one or more DCI messages, in scenarios in which the active BWP 520 includes multiple subbands with different valid quantities of PRBs.

In accordance with supporting the first interpretation 570 and the second interpretation 575, the UE 115 may selectively use (such as activate or configure) one of the first interpretation 570 or the second interpretation 575 in accordance with being indicated to use the first subband 535 or the second subband 545. For example, the UE 115 may use the first interpretation 570 in accordance with being indicated to use the first subband 535 and may use the second interpretation 575 in accordance with being indicated to use the second subband 545. The UE 115 may be indicated to use the first subband 535 or the second subband 545 in one or more of various ways.

In some examples, the DCI message 555 or a prior DCI message may include an explicit indication (such as via a subband field, such as a bitmap) of the subband that the UE 115 is to use for the scheduled data message. In such examples, the UE 115 may use the first interpretation 570 or the second interpretation 575 depending on which subband the UE 115 is to use for the scheduled data message. Additionally, or alternatively, the DCI message 555 may include an implicit indication of the subband that the UE 115 is to use for the scheduled data message. Such an implicit indication may be a slot offset. For example, the DCI message 555 may include a slot offset field indicative of a slot offset (such as a K0 value) between the DCI message 555 and the scheduled data message and the slot offset may implicitly indicate which subband the UE 115 is to use for the scheduled data message. For example, a slot offset value that fails to satisfy a threshold slot offset (such as K0<a minimum or threshold slot offset, such as K_min) may indicate that the UE 115 is to use the first subband 535. By way of further example, a slot offset value that satisfies a threshold slot offset (such as K0>a minimum or threshold slot offset, such as K_min) may indicate that the UE 115 is to use the second subband 545.

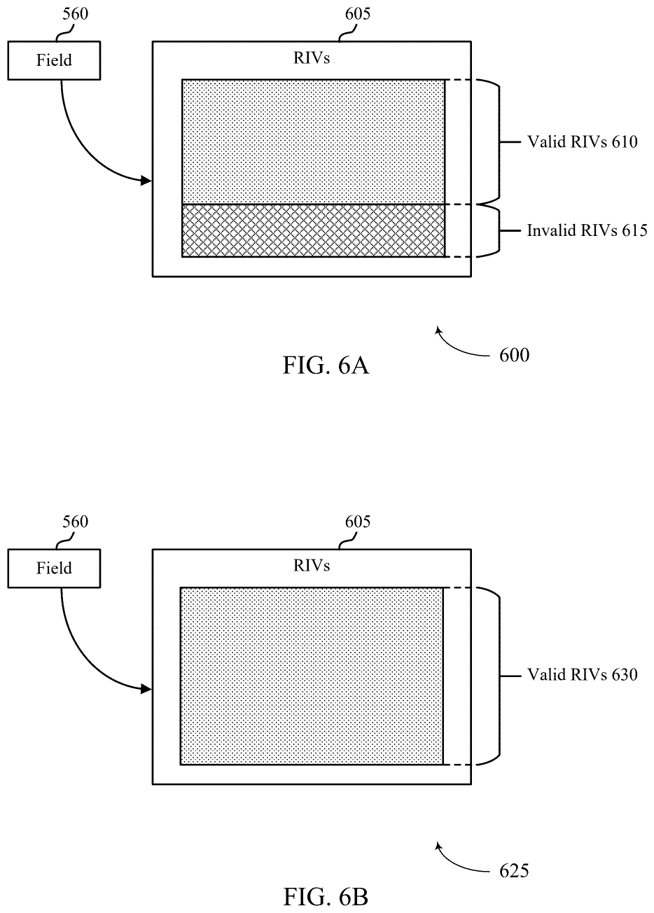

FIGS. 6A and 6B show examples of an interpretation 600 and an interpretation 625, respectively, of a field indicative of an FDRA, that support DCI designs with light adaptation between subbands of an active BWP. The interpretation 600 may be an example of the first interpretation 570 and the interpretation 625 may be an example of the second interpretation 575, as illustrated by and described with reference to FIG. 5. For example, a UE 115 or a network entity 105 may select, calculate, identify, determine, convey, indicate, or otherwise ascertain the FDRA 565 via the field 560 in accordance with the interpretation 600 or the interpretation 625 depending on at which subband the UE 115 or the network entity 105 operates. Such different interpretations of the field 560 may enable the UE 115 and the network entity 105 to use a same or consistent field size across DCIs communicated via various subbands, which may support greater DCI decodability, enable faster reconciliation of mismatched subband scenarios, and lower device complexity.

In accordance with the UE 115 or the network entity 105 operating at the first subband 535 that includes the first valid quantity of PRBs 540, the UE 115 or the network entity 105 may, in accordance with the interpretation 600 of the field 560, use or expect that a subset of a set of RIVs 605 are valid and that a remainder of the set of RIVs 605 are invalid. In other words, when operating at the first subband 535 (which may be associated with the scheduling restriction as compared to the second subband 545), the UE 115 or the network entity 105 may not expect or avoid scheduling one or more RIVs. For example, when operating at the first subband 535, the UE 115 or the network entity 105 may use or expect the field 560 to indicate an RIV from a set of valid RIVs 610 and may not use or expect the field 560 to indicate an RIV from a set of invalid RIVs 615. The set of invalid RIVs 615 may include one or more RIVs that correspond to resource block groups (RBGs) outside of the first valid quantity of PRBs 540 (such as outside of the limited or restricted bandwidth of the first subband 535).

In accordance with the UE 115 or the network entity 105 operating at the second subband 545 that includes the second valid quantity of PRBs 550, the UE 115 or the network entity 105 may, in accordance with the interpretation 625 of the field 560, use or expect that a full set of the RIVs 605 are valid RIVs 630. In other words, when operating at the second subband 545 (which may be associated with an absence of the scheduling restriction), the UE 115 or the network entity 105 may use a full (or at least relatively larger) set of the RIVs 605 as the valid RIVs 630. The valid RIVs 630 may include the full set of the RIVs 605 in examples in which the second subband 545 is associated with a full bandwidth of the active BWP 520. In examples in which the second subband 545 is not associated with a full bandwidth of the active BWP 520 (such that both the first subband 535 and the second subband 545 are subsets of the active BWP 520), the valid RIVs 630 associated with the interpretation 625 may be a different (such as larger) subset of the RIVs 605 as compared to the set of valid RIVs 610 associated with the interpretation 600.

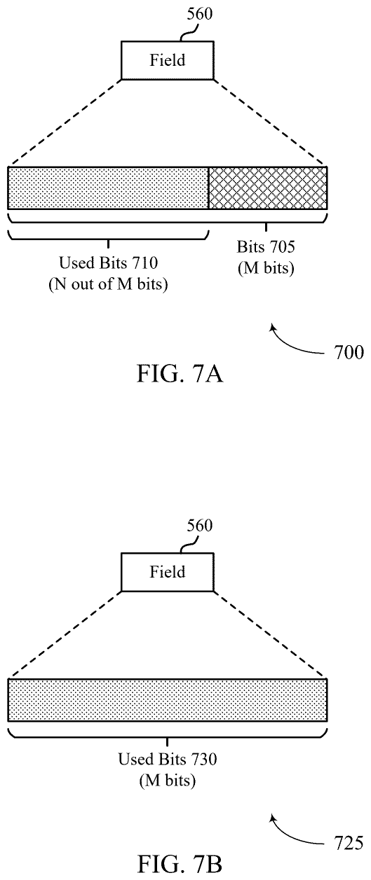

FIGS. 7A and 7B show examples of an interpretation 700 and an interpretation 725, respectively, of a field indicative of an FDRA, that support DCI designs with light adaptation between subbands of an active BWP. The interpretation 700 may be an example of the first interpretation 570 and the interpretation 725 may be an example of the second interpretation 575, as illustrated by and described with reference to FIG. 5. For example, a UE 115 or a network entity 105 may select, calculate, identify, determine, convey, indicate, or otherwise ascertain the FDRA 565 via the field 560 in accordance with the interpretation 700 or the interpretation 725 depending on at which subband the UE 115 or the network entity 105 operates. Such different interpretations of the field 560 may enable the UE 115 and the network entity 105 to use a same or consistent field size across DCIs communicated via various subbands, which may support greater DCI decodability, enable faster reconciliation of mismatched subband scenarios, and lower device complexity.

In accordance with the UE 115 or the network entity 105 operating at the first subband 535 that includes the first valid quantity of PRBs 540, the UE 115 or the network entity 105 may, in accordance with the interpretation 700 of the field 560, use a subset of bits of a total quantity of bits 705 within the field 560 to select, calculate, identify, determine, convey, indicate, or otherwise ascertain the FDRA 565. For example, in accordance with the interpretation 700, a set of used bits 710 of the field 560 may be a subset of the total quantity of bits 705 within the field 560. Such a set of used bits 710 may be bits that are used to select, calculate, identify, determine, convey, indicate, or otherwise ascertain the FDRA 565.

A remainder of the bits within the field 560 outside of the set of used bits 710 may be reserved bits, ignored bits, zero-padded bits, or used to indicate other information. For example, the network entity 105 may zero pad the field 560 to a largest FDRA size of the subband. By way of further example, the network entity 105 may zero pad the field 560 to a largest FDRA size of the active BWP 520. In some examples, the field 560 may include M bits and, in accordance with the interpretation 700, the UE 115 or the network entity 105 may use N bits out of the M bits to select, calculate, identify, determine, convey, indicate, or otherwise ascertain the FDRA 565. The set of used bits 710 (the N out of M bits) may be a set of least significant bits or a set of most significant bits within the field 560, among other examples. Accordingly, in examples in which the UE 115 is (explicitly or implicitly) indicated to move from the second subband 545 to the first subband 535 (in which the UE 115 may expect a scheduling restriction or limited bandwidth), a subset of (least or most significant) bits within the field 560 may be valid (non-ignored) by the UE 115 to determine the field 560 (such as to determine the FDRA 565 indicated by the field 560).

In accordance with the UE 115 or the network entity 105 operating at the second subband 545 that includes the second valid quantity of PRBs 550, the UE 115 or the network entity 105 may, in accordance with the interpretation 725 of the field 560, use a full (such as complete) set of the bits 705 within the field 560 to select, calculate, identify, determine, convey, indicate, or otherwise ascertain the FDRA 565. For example, a set of used bits 730 in accordance with the interpretation 725 may span the full set of the bits 705 within the field 560. Accordingly, in examples in which the UE 115 is (explicitly or implicitly) indicated to move from the first subband 535 to the second subband 545 (in which the UE 115 may expect an absence of a scheduling restriction or wider bandwidth), the full set of the bits 705 within the field 560 (such as M significant bits) may be valid to determine the field 560 (such as to determine the FDRA 565 indicated by the field 560).

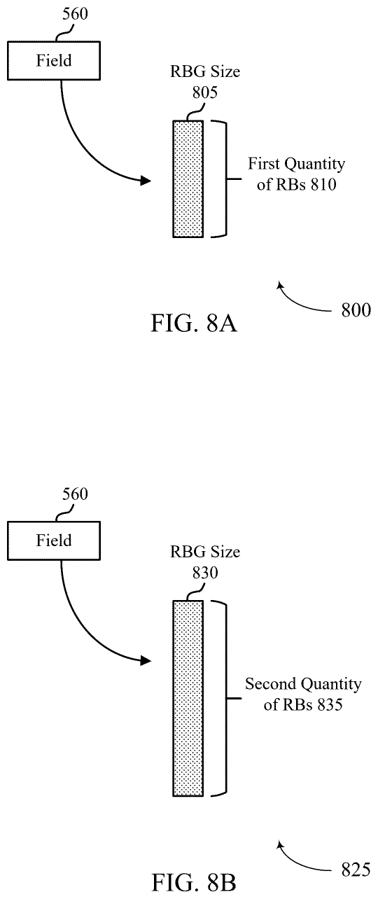

FIGS. 8A and 8B show examples of an interpretation 800 and an interpretation 825, respectively, of a field indicative of an FDRA, that support DCI designs with light adaptation between subbands of an active BWP. The interpretation 800 may be an example of the first interpretation 570 and the interpretation 825 may be an example of the second interpretation 575, as illustrated by and described with reference to FIG. 5. For example, a UE 115 or a network entity 105 may select, calculate, identify, determine, convey, indicate, or otherwise ascertain the FDRA 565 via the field 560 in accordance with the interpretation 800 or the interpretation 825 depending on at which subband the UE 115 or the network entity 105 operates. Such different interpretations of the field 560 may enable the UE 115 and the network entity 105 to use a same or consistent field size across DCIs communicated via various subbands, which may support greater DCI decodability, enable faster reconciliation of mismatched subband scenarios, and lower device complexity.

In accordance with the UE 115 or the network entity 105 operating at the first subband 535 that includes the first valid quantity of PRBs 540, the UE 115 or the network entity 105 may, in accordance with the interpretation 800 of the field 560, use the bits within the field 560 to obtain or indicate the FDRA 565 at a first frequency domain resource granularity. Such a first frequency domain resource granularity may be a first RBG size 805 of a first quantity of RBs 810. The first RBG size 805 may be a relatively finer granularity as compared to some other RBG sizes. Accordingly, in examples in which the UE 115 is (explicitly or implicitly) indicated to move from the second subband 545 to the first subband 535 (in which the UE 115 may expect a scheduling restriction or limited bandwidth), the UE 115 may interpret the field 560 to determine the FDRA 565 with a finer granularity.

In accordance with the UE 115 or the network entity 105 operating at the second subband 545 that includes the second valid quantity of PRBs 550, the UE 115 or the network entity 105 may, in accordance with the interpretation 825 of the field 560, use the bits within the field 560 to obtain or indicate the FDRA 565 at a second frequency domain resource granularity. Such a second frequency domain resource granularity may be a second RBG size 830 of a second quantity of RBs 835. The second RBG size 830 may be a relatively coarser granularity as compared to some other RBG sizes. For example, the first RBG size 805 may be smaller than the second RBG size 830. Accordingly, in examples in which the UE 115 is (explicitly or implicitly) indicated to move from the first subband 535 to the second subband 545 (in which the UE 115 may expect an absence of a scheduling restriction or wider bandwidth), the UE 115 may interpret the field 560 to determine the FDRA 565 with a coarser granularity. In other words, the UE 115 or the network entity 105 may interpret the field 560 differently depending on current subband such that the field 560 is interpreted with a relatively finer granularity if the first subband 535 is (explicitly or implicitly) indicated or such that the field 560 is interpreted in accordance with a size of the field 560 if the second subband 545 is (explicitly or implicitly) indicated. For example, the second RBG size 830 may be associated with a baseline RBG size that corresponds to a size of the field 560, with the first RBG size 805 being associated with a relatively finer granularity as compared to the baseline RBG size.

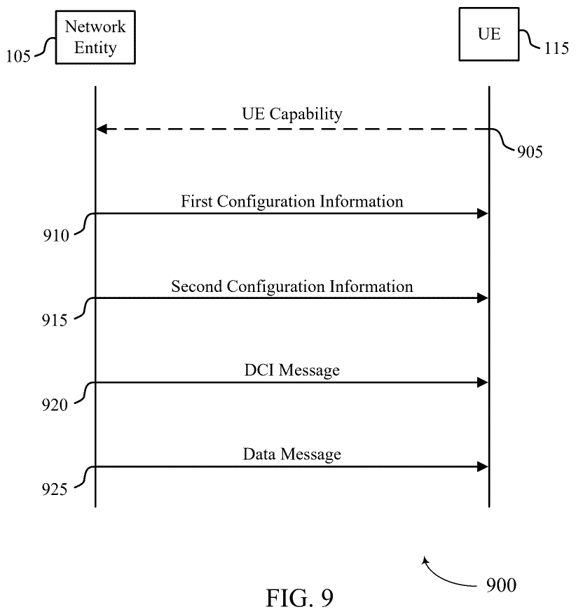

FIG. 9 shows an example of a process flow 900 illustrative of signaling between a UE 115 and a network entity 105 that supports DCI designs with light adaptation between subbands of an active BWP. The process flow 900 may implement or be implemented to realize or facilitate one or more aspects of the wireless communications system 100, the subband configuration 200, the communication timeline 300, the communication timeline 325, the communication timeline 400, the signaling diagram 500, the interpretation 600, the interpretation 625, the interpretation 700, the interpretation 725, the interpretation 800, or the interpretation 825. The UE 115 and the network entity 105 may be examples of corresponding devices as illustrated and described herein.

In the following description of the process flow 900, the communications between the UE 115 and the network entity 105 may be transmitted in a different order than the example order shown, or the operations performed by the UE 115 and the network entity 105 may be performed in different orders or at different times. Some operations may also be omitted from the process flow 900, and other operations may be added to the process flow 900.

At 905, the UE 115 may transmit information indicative of a UE capability to the network entity 105. Such information may indicate whether the UE 115 is capable of supporting multiple subbands within an active BWP, timeline (such as slot offset) or processing capabilities of the UE 115, or field interpretations supported by the UE 115, among other examples. The UE 115 may transmit such information indicative of the UE capability via RRC signaling, one or more MAC-CEs, uplink control information (UCI), or any combination thereof.

At 910, the UE 115 may receive, from the network entity 105, first configuration information. The first configuration information that the UE 115 receives at 910 may be an example of the first configuration information 515 as illustrated by and described with reference to FIG. 5. The first configuration information may indicate a respective set of parameters associated with each BWP of one or more BWPs configured at the UE 115, including a set of parameters associated with an active BWP of the UE 115 (such as the set of parameters 525 associated with the active BWP 520 as illustrated by and described with reference to FIG. 5).

At 915, the UE 115 may receive, from the network entity 105, second configuration information. The second configuration information that the UE 115 receives at 915 may be an example of the second configuration information 530 as illustrated by and described with reference to FIG. 5. The second configuration information may indicate multiple subbands of different valid quantities of PRBs within the active BWP. For example, the UE 115 may receive the second configuration information as part of (such as within) the first configuration information. In other words, the first configuration information may include a set of parameters, fields, or information elements, with a subset of the set of parameters, fields, or information elements providing the second configuration information. The multiple subbands with the different valid quantities of PRBs may include the first subband 535 and the second subband 545, as illustrated by and described with reference to FIG. 5.

At 920, the UE 115 may receive, from the network entity 105, a DCI message. The DCI message that the UE 115 receives at 920 may be an example of the DCI message 555 as illustrated by and described with reference to FIG. 5. The DCI message may schedule a data message and may include a field that indicates, in accordance with an interpretation of the field, an FDRA associated with the data message. Further, in some aspects, a size of the field indicative of the FDRA may be independent of the different valid quantities of PRBs of the multiple subbands within the active BWP. The UE 115 and the network entity 105 may support and use different interpretations of the field indicative of the FDRA depending on at which subband the UE 115 and the network entity 105 currently operate.

At 925, the UE 115 may receive, from the network entity 105, the data message. The UE 115 may receive the data message in accordance with the FDRA indicated by the field of the DCI message. For example, the UE 115 may receive the data message via a set of frequency domain resources indicated by the FDRA. Further, although some example implementations are described and shown in the context of a scheduled downlink data message, the data message scheduled by the DCI message may be a downlink data message or an uplink data message without exceeding the scope of the present disclosure. Thus, more generally, the UE 115 may communicate the data message with (such as transmit the data message to or receive the data message from) the network entity 105 in accordance with the FDRA indicated by the DCI message (as determined by the interpretation of the field indicative of the FDRA).

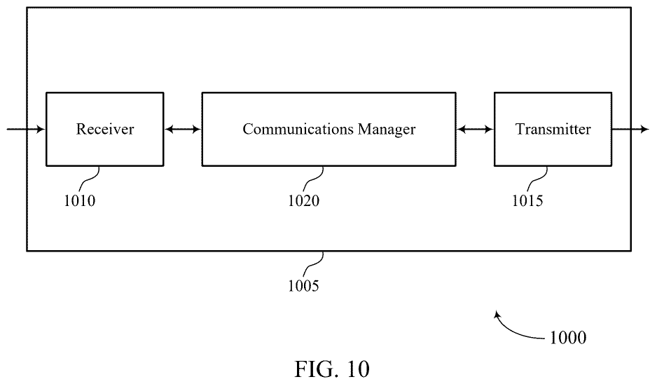

FIG. 10 shows a block diagram 1000 of a device 1005 that supports DCI designs with light adaptation between subbands of an active BWP. The device 1005 may be an example of aspects of a UE 115 as described herein. The device 1005 may include a receiver 1010, a transmitter 1015, and a communications manager 1020. The device 1005, or one or more components of the device 1005 (such as the receiver 1010, the transmitter 1015, the communications manager 1020), may include at least one processor, which may be coupled with at least one memory, to, individually or collectively, support or enable the described techniques. Each of these components may be in communication with one another (such as via one or more buses).

The receiver 1010 may provide a means for receiving information such as packets, user data, control information, or any combination thereof associated with various information channels (such as control channels, data channels, information channels related to DCI designs with light adaptation between subbands of an active BWP). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (such as control channels, data channels, information channels related to DCI designs with light adaptation between subbands of an active BWP). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations or components thereof may be examples of means for performing various aspects of DCI designs with light adaptation between subbands of an active BWP as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (such as in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the communications manager 1020, the receiver 1010, the transmitter 1015, or various combinations or components thereof may be implemented in code (as communications management software or firmware) executed by at least one processor (such as referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (such as configured as or otherwise supporting, individually or collectively, a means for performing the functions described in the present disclosure).

In some examples, the communications manager 1020 may be configured to perform various operations (such as receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for receiving first configuration information indicative of a set of parameters associated with an active BWP of the UE and, as part of the first configuration information, second configuration information indicative of a set of multiple subbands with different valid quantities of PRBs. The communications manager 1020 is capable of, configured to, or operable to support a means for receiving a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands. The communications manager 1020 is capable of, configured to, or operable to support a means for communicating the data message in accordance with the FDRA.

By including or configuring the communications manager 1020 in accordance with examples as described herein, the device 1005 (such as at least one processor controlling or otherwise coupled with the receiver 1010, the transmitter 1015, the communications manager 1020, or a combination thereof) may support techniques for reduced processing, reduced power consumption, and more efficient utilization of communication resources. For example, light adaptation mechanisms may involve time, frequency, and antenna adaptation that saves device energy without the relatively higher cost associated with BWP switches (which may involve a relatively high penalty for active BWP misalignment between a UE 115 and a network entity 105 and a relatively long switching time).

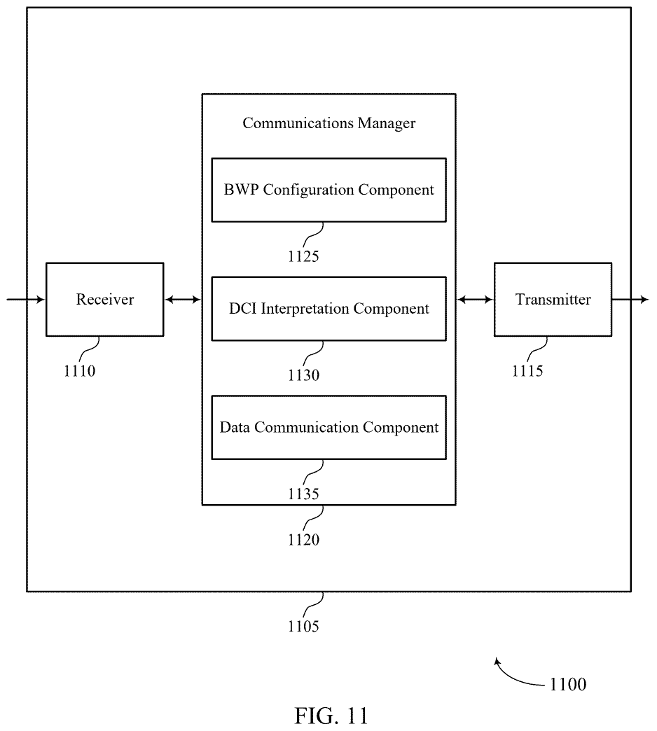

FIG. 11 shows a block diagram 1100 of a device 1105 that supports DCI designs with light adaptation between subbands of an active BWP. The device 1105 may be an example of aspects of a device 1005 or a UE 115 as described herein. The device 1105 may include a receiver 1110, a transmitter 1115, and a communications manager 1120. The device 1105, or one or more components of the device 1105 (such as the receiver 1110, the transmitter 1115, the communications manager 1120), may include at least one processor, which may be coupled with at least one memory, to support the described techniques. Each of these components may be in communication with one another (such as via one or more buses).

The receiver 1110 may provide a means for receiving information such as packets, user data, control information, or any combination thereof associated with various information channels (such as control channels, data channels, information channels related to DCI designs with light adaptation between subbands of an active BWP). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (such as control channels, data channels, information channels related to DCI designs with light adaptation between subbands of an active BWP). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of DCI designs with light adaptation between subbands of an active BWP as described herein. For example, the communications manager 1120 may include a BWP configuration component 1125, a DCI interpretation component 1130, a data communication component 1135, or any combination thereof. The communications manager 1120 may be an example of aspects of a communications manager 1020 as described herein. In some examples, the communications manager 1120, or various components thereof, may be configured to perform various operations (such as receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The BWP configuration component 1125 is capable of, configured to, or operable to support a means for receiving first configuration information indicative of a set of parameters associated with an active BWP of the UE and, as part of the first configuration information, second configuration information indicative of a set of multiple subbands with different valid quantities of PRBs. The DCI interpretation component 1130 is capable of, configured to, or operable to support a means for receiving a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands. The data communication component 1135 is capable of, configured to, or operable to support a means for communicating the data message in accordance with the FDRA.

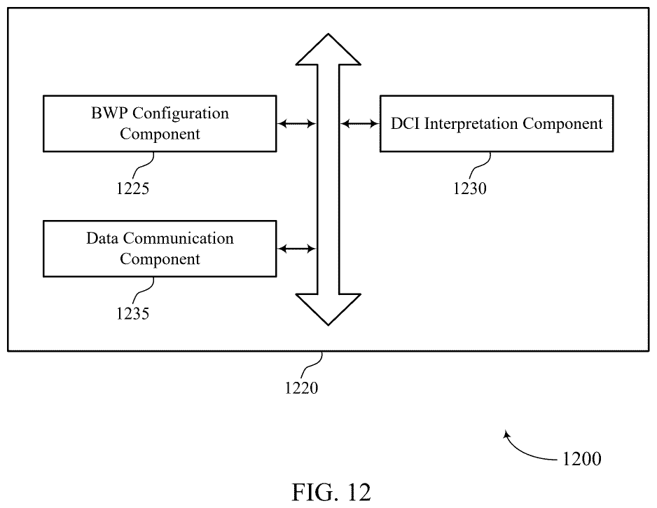

FIG. 12 shows a block diagram 1200 of a communications manager 1220 that supports DCI designs with light adaptation between subbands of an active BWP. The communications manager 1220 may be an example of aspects of a communications manager 1020, a communications manager 1120, or both, as described herein. The communications manager 1220, or various components thereof, may be an example of means for performing various aspects of DCI designs with light adaptation between subbands of an active BWP as described herein. For example, the communications manager 1220 may include a BWP configuration component 1225, a DCI interpretation component 1230, a data communication component 1235, or any combination thereof. Each of these components, or components or subcomponents thereof (such as one or more processors, one or more memories), may communicate, directly or indirectly, with one another (such as via one or more buses).

The communications manager 1220 may support wireless communication in accordance with examples as disclosed herein. The BWP configuration component 1225 is capable of, configured to, or operable to support a means for receiving first configuration information indicative of a set of parameters associated with an active BWP of the UE and, as part of the first configuration information, second configuration information indicative of a set of multiple subbands with different valid quantities of PRBs. The DCI interpretation component 1230 is capable of, configured to, or operable to support a means for receiving a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands. The data communication component 1235 is capable of, configured to, or operable to support a means for communicating the data message in accordance with the FDRA.

In some examples, the set of multiple subbands within the active BWP includes a first subband and a second subband. In some examples, the first subband includes a first valid quantity of PRBs and the second subband includes a second valid quantity of PRBs that is greater than the first valid quantity of PRBs. In some examples, the interpretation of the field is a first interpretation in accordance with the UE being indicated, by the DCI message or a prior DCI message, to use the first subband that includes the first valid quantity of PRBs or is a second interpretation in accordance with the UE being indicated, by the DCI message or the prior DCI message, to use the second subband that includes the second valid quantity of PRBs.

In some examples, the field indicates an RIV from a set of RIVs. In some examples, the UE expects a subset of RIVs of the set of RIVs as valid RIVs in accordance with the first interpretation and expects the set of RIVs as the valid RIVs in accordance with the second interpretation.

In some examples, the field includes a set of bits. In some examples, the UE uses a subset of bits of the set of bits to obtain the FDRA in accordance with the first interpretation and uses the set of bits to obtain the FDRA in accordance with the second interpretation. In some examples, the subset of bits is a set (such as a subset) of least significant bits or a set (such as a subset) of most significant bits of the set of bits.

In some examples, the field includes a set of multiple bits. In some examples, the UE uses the set of multiple bits to obtain the FDRA at a first RBG size in accordance with the first interpretation and uses the set of multiple bits to obtain the FDRA at a second RBG size in accordance with the second interpretation.

In some examples, the DCI message or the prior DCI message includes a subband field indicative of a subband of the set of multiple subbands within the active BWP. In some examples, the subband field indicates whether the UE is to use the first subband or the second subband.

In some examples, the DCI message includes a slot offset field indicative of a slot offset between the DCI message and the data message. In some examples, the UE is indicated to use the first subband that includes the first valid quantity of PRBs in accordance with the slot offset failing to satisfy a threshold slot offset or is indicated to use the second subband that includes the second valid quantity of PRBs in accordance with the slot offset satisfying the threshold slot offset.

In some examples, the first subband is associated with a scheduling restriction in accordance with the first subband including the first valid quantity of PRBs that is less than the second valid quantity of PRBs. In some examples, the second subband is associated with an absence of the scheduling restriction in accordance with the second subband including the second valid quantity of PRBs that is greater than the first valid quantity of PRBs. In some examples, the scheduling restriction defines an expectation of the UE to not be allocated with frequency domain resources outside of the first subband within a threshold duration of a reception time of the DCI message in accordance with the UE operating at the first subband. In some examples, the first subband is a subset of the second subband.

In some examples, the first valid quantity of PRBs defines a first set of one or more PRBs that are usable for scheduling within the first subband. In some examples, the second valid quantity of PRBs defines a second set of one or more PRBs that are usable for scheduling within the second subband. In some examples, the size of the field that indicates the FDRA is constant across the set of multiple subbands within the active BWP. In some examples, the size of the field that indicates the FDRA is associated with a widest subband of the set of multiple subbands within the active BWP.

In some examples, the set of parameters is associated with the active BWP and each subband of the set of multiple subbands within the active BWP. In some examples, the set of parameters includes one or more of one or more first parameters associated with a control resource set; one or more second parameters associated with a sounding reference signal configuration; one or more third parameters associated with configured grant communications; and one or more fourth parameters associated with semi-persistently scheduled communications. In some examples, the UE receives the DCI message via a set of downlink control channel resources associated with the control resource set.

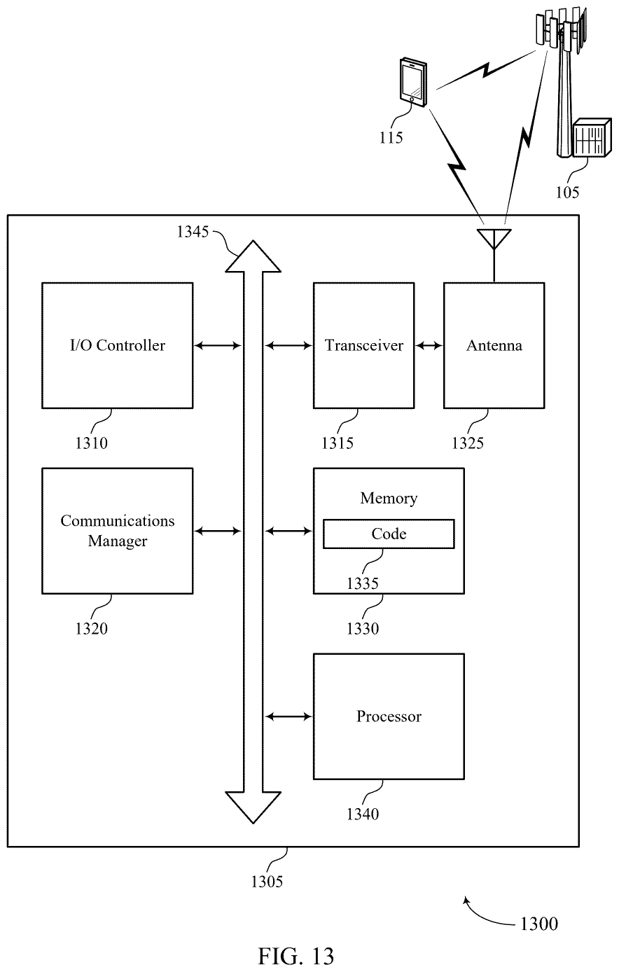

FIG. 13 shows a diagram of a system 1300 including a device 1305 that supports DCI designs with light adaptation between subbands of an active BWP. The device 1305 may be an example of or include components of a device 1005, a device 1105, or a UE 115 as described herein. The device 1305 may communicate (such as wirelessly) with one or more other devices (such as network entities 105, UEs 115, or a combination thereof). The device 1305 may include components for bi-directional voice and data communications including components for transmitting and receiving communications, such as a communications manager 1320, an input/output (I/O) controller, such as an I/O controller 1310, a transceiver 1315, one or more antennas 1325, at least one memory 1330, code 1335, and at least one processor 1340. These components may be in electronic communication or otherwise coupled (such as operatively, communicatively, functionally, electronically, electrically) via one or more buses (such as a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of one or more processors, such as the at least one processor 1340. In some cases, a user may interact with the device 1305 via the I/O controller 1310 or via hardware components controlled by the I/O controller 1310.

In some cases, the device 1305 may include a single antenna. However, in some other cases, the device 1305 may have more than one antenna, which may be capable of concurrently transmitting or receiving multiple wireless transmissions. The transceiver 1315 may communicate bi-directionally via the one or more antennas 1325 using wired or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The at least one memory 1330 may include random access memory (RAM) and read-only memory (ROM). The at least one memory 1330 may store computer-readable, computer-executable, or processor-executable code, such as the code 1335. The code 1335 may include instructions that, when executed by the at least one processor 1340, cause the device 1305 to perform various functions described herein. The code 1335 may be stored in a non-transitory computer-readable medium such as system memory or another type of memory. In some cases, the code 1335 may not be directly executable by the at least one processor 1340 but may cause a computer (such as when compiled and executed) to perform functions described herein. In some cases, the at least one memory 1330 may include, among other things, a basic I/O system (BIOS) which may control basic hardware or software operation such as the interaction with peripheral components or devices.

The at least one processor 1340 may include one or more intelligent hardware devices (such as one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1340 may be configured to operate a memory array using a memory controller. In some other cases, a memory controller may be integrated into the at least one processor 1340. The at least one processor 1340 may be configured to execute computer-readable instructions stored in a memory (such as the at least one memory 1330) to cause the device 1305 to perform various functions (such as functions or tasks supporting DCI designs with light adaptation between subbands of an active BWP). For example, the device 1305 or a component of the device 1305 may include at least one processor 1340 and at least one memory 1330 coupled with or to the at least one processor 1340, the at least one processor 1340 and the at least one memory 1330 configured to perform various functions described herein.

In some examples, the at least one processor 1340 may include multiple processors and the at least one memory 1330 may include multiple memories. One or more of the multiple processors may be coupled with one or more of the multiple memories, which may, individually or collectively, be configured to perform various functions described herein. In some examples, the at least one processor 1340 may be a component of a processing system, which may refer to a system (such as a series) of machines, circuitry (including, for example, one or both of processor circuitry (which may include the at least one processor 1340) and memory circuitry (which may include the at least one memory 1330)), or components, that receives or obtains inputs and processes the inputs to produce, generate, or obtain a set of outputs. The processing system may be configured to perform one or more of the functions described herein. For example, the at least one processor 1340 or a processing system including the at least one processor 1340 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code 1335 (such as processor-executable code) stored in the at least one memory 1330 or otherwise, to perform one or more of the functions described herein. In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

The processing system of the device 1305 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

The communications manager 1320 may support wireless communication in accordance with examples as disclosed herein. For example, the communications manager 1320 is capable of, configured to, or operable to support a means for receiving first configuration information indicative of a set of parameters associated with an active BWP of the UE and, as part of the first configuration information, second configuration information indicative of a set of multiple subbands with different valid quantities of PRBs. The communications manager 1320 is capable of, configured to, or operable to support a means for receiving a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands. The communications manager 1320 is capable of, configured to, or operable to support a means for communicating the data message in accordance with the FDRA.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (such as receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the at least one processor 1340, the at least one memory 1330, the code 1335, or any combination thereof. For example, the code 1335 may include instructions executable by the at least one processor 1340 to cause the device 1305 to perform various aspects of DCI designs with light adaptation between subbands of an active BWP as described herein, or the at least one processor 1340 and the at least one memory 1330 may be otherwise configured to, individually or collectively, perform or support such operations.

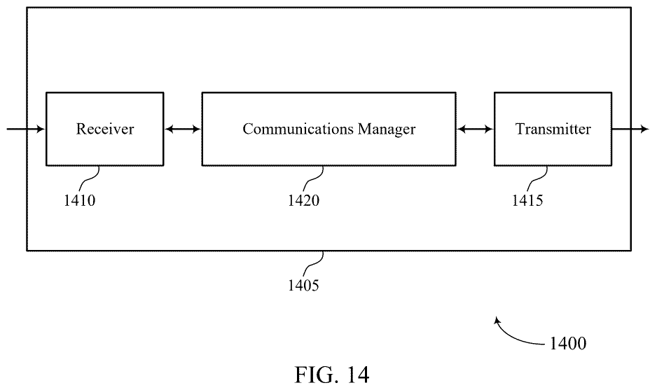

FIG. 14 shows a block diagram 1400 of a device 1405 that supports DCI designs with light adaptation between subbands of an active BWP. The device 1405 may be an example of aspects of a network entity 105 as described herein. The device 1405 may include a receiver 1410, a transmitter 1415, and a communications manager 1420. The device 1405, or one or more components of the device 1405 (such as the receiver 1410, the transmitter 1415, the communications manager 1420), may include at least one processor, which may be coupled with at least one memory, to, individually or collectively, support or enable the described techniques. Each of these components may be in communication with one another (such as via one or more buses).

The receiver 1410 may provide a means for obtaining (such as receiving, determining, identifying) information such as user data, control information, or any combination thereof (such as I/Q samples, symbols, packets, protocol data units, service data units) associated with various channels (such as control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (such as electrical, fiber optic) interfaces, wireless interfaces, or any combination thereof.

The transmitter 1415 may provide a means for outputting (such as transmitting, providing, conveying, sending) information generated by other components of the device 1405. For example, the transmitter 1415 may output information such as user data, control information, or any combination thereof (such as I/Q samples, symbols, packets, protocol data units, service data units) associated with various channels (such as control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (such as electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations or components thereof may be examples of means for performing various aspects of DCI designs with light adaptation between subbands of an active BWP as described herein. For example, the communications manager 1420, the receiver 1410, the transmitter 1415, or various combinations or components thereof may be capable of performing one or more of the functions described herein.

In some examples, the communications manager 1420, the receiver 1410, the transmitter 1415, or various combinations or components thereof may be implemented in hardware (such as in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the communications manager 1420, the receiver 1410, the transmitter 1415, or various combinations or components thereof may be implemented in code (as communications management software or firmware) executed by at least one processor (such as referred to as a processor-executable code). If implemented in code executed by at least one processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (such as configured as or otherwise supporting, individually or collectively, a means for performing the functions described in the present disclosure).

In some examples, the communications manager 1420 may be configured to perform various operations (such as receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication in accordance with examples as disclosed herein. For example, the communications manager 1420 is capable of, configured to, or operable to support a means for outputting first configuration information indicative of a set of parameters associated with an active BWP of a UE and, as part of the first configuration information, second configuration information indicative of a set of multiple subbands with different valid quantities of PRBs. The communications manager 1420 is capable of, configured to, or operable to support a means for outputting a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands. The communications manager 1420 is capable of, configured to, or operable to support a means for communicating the data message in accordance with the FDRA.

By including or configuring the communications manager 1420 in accordance with examples as described herein, the device 1405 (such as at least one processor controlling or otherwise coupled with the receiver 1410, the transmitter 1415, the communications manager 1420, or a combination thereof) may support techniques for reduced processing, reduced power consumption, and more efficient utilization of communication resources. For example, light adaptation mechanisms may involve time, frequency, and antenna adaptation that saves device energy without the relatively higher cost associated with BWP switches (which may involve a relatively high penalty for active BWP misalignment between a UE 115 and a network entity 105 and a relatively long switching time).

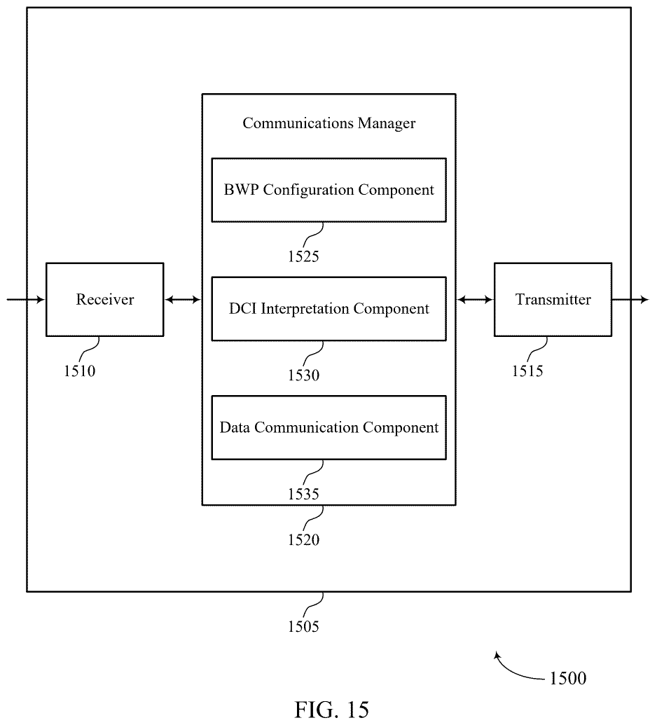

FIG. 15 shows a block diagram 1500 of a device 1505 that supports DCI designs with light adaptation between subbands of an active BWP. The device 1505 may be an example of aspects of a device 1405 or a network entity 105 as described herein. The device 1505 may include a receiver 1510, a transmitter 1515, and a communications manager 1520. The device 1505, or one or more components of the device 1505 (such as the receiver 1510, the transmitter 1515, the communications manager 1520), may include at least one processor, which may be coupled with at least one memory, to support the described techniques. Each of these components may be in communication with one another (such as via one or more buses).

The receiver 1510 may provide a means for obtaining (such as receiving, determining, identifying) information such as user data, control information, or any combination thereof (such as I/Q samples, symbols, packets, protocol data units, service data units) associated with various channels (such as control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (such as electrical, fiber optic) interfaces, wireless interfaces, or any combination thereof.

The transmitter 1515 may provide a means for outputting (such as transmitting, providing, conveying, sending) information generated by other components of the device 1505. For example, the transmitter 1515 may output information such as user data, control information, or any combination thereof (such as I/Q samples, symbols, packets, protocol data units, service data units) associated with various channels (such as control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (such as electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of DCI designs with light adaptation between subbands of an active BWP as described herein. For example, the communications manager 1520 may include a BWP configuration component 1525, a DCI interpretation component 1530, a data communication component 1535, or any combination thereof. The communications manager 1520 may be an example of aspects of a communications manager 1420 as described herein. In some examples, the communications manager 1520, or various components thereof, may be configured to perform various operations (such as receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communication in accordance with examples as disclosed herein. The BWP configuration component 1525 is capable of, configured to, or operable to support a means for outputting first configuration information indicative of a set of parameters associated with an active BWP of a UE and, as part of the first configuration information, second configuration information indicative of a set of multiple subbands with different valid quantities of PRBs. The DCI interpretation component 1530 is capable of, configured to, or operable to support a means for outputting a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands. The data communication component 1535 is capable of, configured to, or operable to support a means for communicating the data message in accordance with the FDRA.

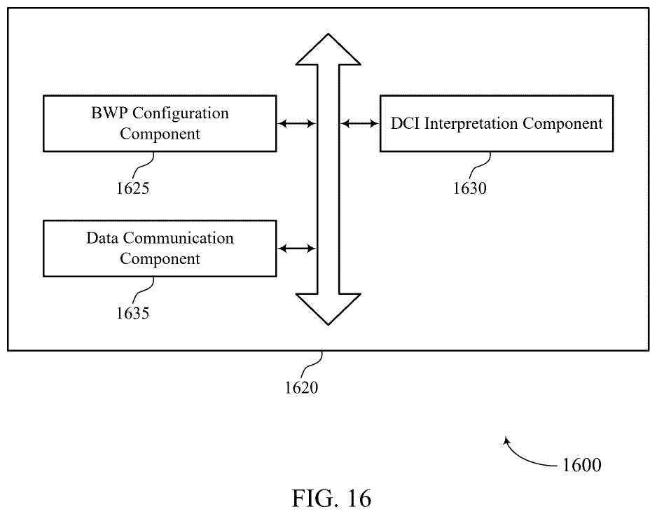

FIG. 16 shows a block diagram 1600 of a communications manager 1620 that supports DCI designs with light adaptation between subbands of an active BWP. The communications manager 1620 may be an example of aspects of a communications manager 1420, a communications manager 1520, or both, as described herein. The communications manager 1620, or various components thereof, may be an example of means for performing various aspects of DCI designs with light adaptation between subbands of an active BWP as described herein. For example, the communications manager 1620 may include a BWP configuration component 1625, a DCI interpretation component 1630, a data communication component 1635, or any combination thereof. Each of these components, or components or subcomponents thereof (such as one or more processors, one or more memories), may communicate, directly or indirectly, with one another (such as via one or more buses). The communications may include communications within a protocol layer of a protocol stack, communications associated with a logical channel of a protocol stack (such as between protocol layers of a protocol stack, within a device, component, or virtualized component associated with a network entity 105, between devices, components, or virtualized components associated with a network entity 105), or any combination thereof.

The communications manager 1620 may support wireless communication in accordance with examples as disclosed herein. The BWP configuration component 1625 is capable of, configured to, or operable to support a means for outputting first configuration information indicative of a set of parameters associated with an active BWP of a UE and, as part of the first configuration information, second configuration information indicative of a set of multiple subbands with different valid quantities of PRBs. The DCI interpretation component 1630 is capable of, configured to, or operable to support a means for outputting a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands. The data communication component 1635 is capable of, configured to, or operable to support a means for communicating the data message in accordance with the FDRA.

In some examples, the set of multiple subbands within the active BWP includes a first subband and a second subband. In some examples, the first subband includes a first valid quantity of PRBs and the second subband includes a second valid quantity of PRBs that is greater than the first valid quantity of PRBs. In some examples, the interpretation of the field is a first interpretation in accordance with the network entity indicating, by the DCI message or a prior DCI message, the UE to use the first subband that includes the first valid quantity of PRBs or is a second interpretation in accordance with the network entity indicating, by the DCI message or the prior DCI message, the UE to use the second subband that includes the second valid quantity of PRBs.

In some examples, the field indicates an RIV from a set of RIVs. In some examples, the network entity uses a subset of RIVs of the set of RIVs as valid RIVs in accordance with the first interpretation and uses the set of RIVs as the valid RIVs in accordance with the second interpretation.

In some examples, the field includes a set of bits. In some examples, the network entity uses a subset of bits of the set of bits to indicate the FDRA in accordance with the first interpretation and uses the set of bits to indicate the FDRA in accordance with the second interpretation. In some examples, the subset of bits is a set (such as a subset) of least significant bits or a set (such as a subset) of most significant bits of the set of bits.

In some examples, the field includes a set of multiple bits. In some examples, the network entity uses the set of multiple bits to indicate the FDRA at a first RBG size in accordance with the first interpretation and uses the set of multiple bits to indicate the FDRA at a second RBG size in accordance with the second interpretation.

In some examples, the DCI message or the prior DCI message includes a subband field indicative of a subband of the set of multiple subbands within the active BWP. In some examples, the subband field indicates whether the UE is to use the first subband or the second subband.

In some examples, the DCI message includes a slot offset field indicative of a slot offset between the DCI message and the data message. In some examples, the network entity indicates the UE to use the first subband that includes the first valid quantity of PRBs in accordance with the slot offset failing to satisfy a threshold slot offset or to use the second subband that includes the second valid quantity of PRBs in accordance with the slot offset satisfying the threshold slot offset.

In some examples, the first subband is associated with a scheduling restriction in accordance with the first subband including the first valid quantity of PRBs that is less than the second valid quantity of PRBs. In some examples, the second subband is associated with an absence of the scheduling restriction in accordance with the second subband including the second valid quantity of PRBs that is greater than the first valid quantity of PRBs. In some examples, the scheduling restriction defines an expectation of the network entity to not allocate the UE with frequency domain resources outside of the first subband within a threshold duration of a reception time of the DCI message in accordance with the UE operating at the first subband. In some examples, the first subband is a subset of the second subband.

In some examples, the first valid quantity of PRBs defines a first set of one or more PRBs that are usable for scheduling within the first subband. In some examples, the second valid quantity of PRBs defines a second set of one or more PRBs that are usable for scheduling within the second subband. In some examples, the size of the field that indicates the FDRA is constant across the set of multiple subbands within the active BWP. In some examples, the size of the field that indicates the FDRA is associated with a widest subband of the set of multiple subbands within the active BWP.

In some examples, the set of parameters is associated with the active BWP and each subband of the set of multiple subbands within the active BWP. In some examples, the set of parameters includes one or more of one or more first parameters associated with a control resource set; one or more second parameters associated with a sounding reference signal configuration; one or more third parameters associated with configured grant communications; and one or more fourth parameters associated with semi-persistently scheduled communications. In some examples, the network entity outputs the DCI message via a set of downlink control channel resources associated with the control resource set.

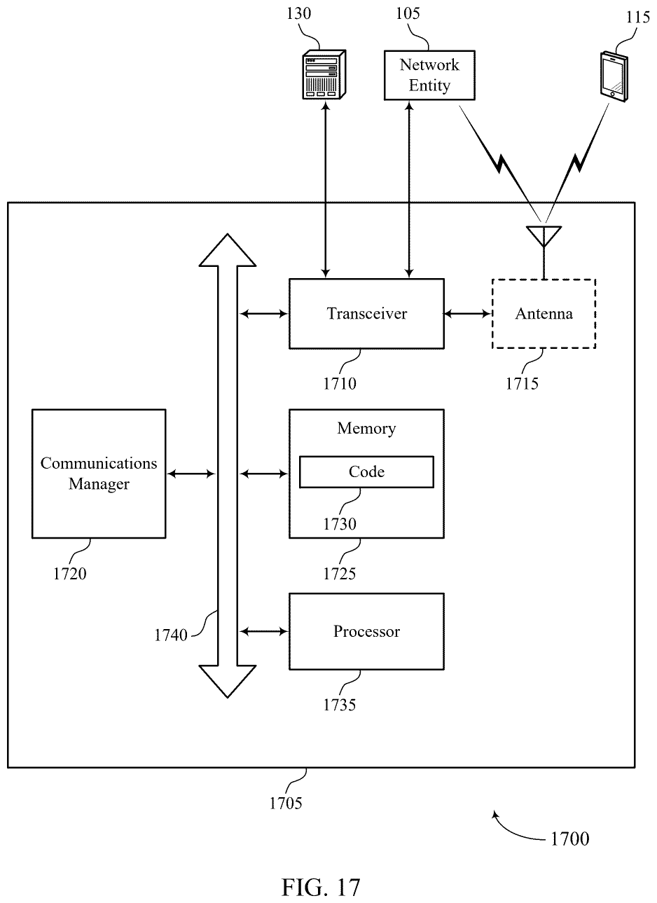

FIG. 17 shows a diagram of a system 1700 including a device 1705 that supports DCI designs with light adaptation between subbands of an active BWP. The device 1705 may be an example of or include components of a device 1405, a device 1505, or a network entity 105 as described herein. The device 1705 may communicate with other network devices or network equipment such as one or more of the network entities 105, UEs 115, or any combination thereof. The communications may include communications over one or more wired interfaces, over one or more wireless interfaces, or any combination thereof. The device 1705 may include components that support outputting and obtaining communications, such as a communications manager 1720, a transceiver 1710, one or more antennas 1715, at least one memory 1725, code 1730, and at least one processor 1735. These components may be in electronic communication or otherwise coupled (such as operatively, communicatively, functionally, electronically, electrically) via one or more buses (such as a bus 1740).

The transceiver 1710 may support bi-directional communications via wired links, wireless links, or both as described herein. In some examples, the transceiver 1710 may include a wired transceiver and may communicate bi-directionally with another wired transceiver. Additionally, or alternatively, in some examples, the transceiver 1710 may include a wireless transceiver and may communicate bi-directionally with another wireless transceiver. In some examples, the device 1705 may include one or more antennas 1715, which may be capable of transmitting or receiving wireless transmissions (such as concurrently). The transceiver 1710 may also include a modem to modulate signals, to provide the modulated signals for transmission (such as by one or more antennas 1715, by a wired transmitter), to receive modulated signals (such as from one or more antennas 1715, from a wired receiver), and to demodulate signals. In some implementations, the transceiver 1710 may include one or more interfaces, such as one or more interfaces coupled with the one or more antennas 1715 that are configured to support various receiving or obtaining operations, or one or more interfaces coupled with the one or more antennas 1715 that are configured to support various transmitting or outputting operations, or a combination thereof. In some implementations, the transceiver 1710 may include or be configured for coupling with one or more processors or one or more memory components that are operable to perform or support operations based on received or obtained information or signals, or to generate information or other signals for transmission or other outputting, or any combination thereof. In some implementations, the transceiver 1710, or the transceiver 1710 and the one or more antennas 1715, or the transceiver 1710 and the one or more antennas 1715 and one or more processors or one or more memory components (such as the at least one processor 1735, the at least one memory 1725, or both), may be included in a chip or chip assembly that is installed in the device 1705. In some examples, the transceiver 1710 may be operable to support communications via one or more communications links (such as communication link(s) 125, backhaul communication link(s) 120, a midhaul communication link 162, a fronthaul communication link 168).

The at least one memory 1725 may include RAM, ROM, or any combination thereof. The at least one memory 1725 may store computer-readable, computer-executable, or processor-executable code, such as the code 1730. The code 1730 may include instructions that, when executed by one or more of the at least one processor 1735, cause the device 1705 to perform various functions described herein. The code 1730 may be stored in a non-transitory computer-readable medium such as system memory or another type of memory. In some cases, the code 1730 may not be directly executable by a processor of the at least one processor 1735 but may cause a computer (such as when compiled and executed) to perform functions described herein. In some cases, the at least one memory 1725 may include, among other things, a BIOS which may control basic hardware or software operation such as the interaction with peripheral components or devices. In some examples, the at least one processor 1735 may include multiple processors and the at least one memory 1725 may include multiple memories. One or more of the multiple processors may be coupled with one or more of the multiple memories which may, individually or collectively, be configured to perform various functions herein (for example, as part of a processing system).

The at least one processor 1735 may include one or more intelligent hardware devices (such as one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1735 may be configured to operate a memory array using a memory controller. In some other cases, a memory controller may be integrated into one or more of the at least one processor 1735. The at least one processor 1735 may be configured to execute computer-readable instructions stored in a memory (such as one or more of the at least one memory 1725) to cause the device 1705 to perform various functions (such as functions or tasks supporting DCI designs with light adaptation between subbands of an active BWP). For example, the device 1705 or a component of the device 1705 may include at least one processor 1735 and at least one memory 1725 coupled with one or more of the at least one processor 1735, the at least one processor 1735 and the at least one memory 1725 configured to perform various functions described herein. The at least one processor 1735 may be an example of a cloud-computing platform (such as one or more physical nodes and supporting software such as operating systems, virtual machines, or container instances) that may host the functions (such as by executing code 1730) to perform the functions of the device 1705. The at least one processor 1735 may be any one or more suitable processors capable of executing scripts or instructions of one or more software programs stored in the device 1705 (such as within one or more of the at least one memory 1725).

In some examples, the at least one processor 1735 may include multiple processors and the at least one memory 1725 may include multiple memories. One or more of the multiple processors may be coupled with one or more of the multiple memories, which may, individually or collectively, be configured to perform various functions herein. In some examples, the at least one processor 1735 may be a component of a processing system, which may refer to a system (such as a series) of machines, circuitry (including, for example, one or both of processor circuitry (which may include the at least one processor 1735) and memory circuitry (which may include the at least one memory 1725)), or components, that receives or obtains inputs and processes the inputs to produce, generate, or obtain a set of outputs. The processing system may be configured to perform one or more of the functions described herein. For example, the at least one processor 1735 or a processing system including the at least one processor 1735 may be configured to, configurable to, or operable to cause the device 1705 to perform one or more of the functions described herein. Further, as described herein, being “configured to,” being “configurable to,” and being “operable to” may be used interchangeably and may be associated with a capability, when executing code stored in the at least one memory 1725 or otherwise, to perform one or more of the functions described herein. In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

The processing system of the device 1705 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, a bus 1740 may support communications of (such as within) a protocol layer of a protocol stack. In some examples, a bus 1740 may support communications associated with a logical channel of a protocol stack (such as between protocol layers of a protocol stack), which may include communications performed within a component of the device 1705, or between different components of the device 1705 that may be co-located or located in different locations (such as where the device 1705 may refer to a system in which one or more of the communications manager 1720, the transceiver 1710, the at least one memory 1725, the code 1730, and the at least one processor 1735 may be located in one of the different components or divided between different components).

In some examples, the communications manager 1720 may manage aspects of communications with a core network 130 (such as via one or more wired or wireless backhaul links). For example, the communications manager 1720 may manage the transfer of data communications for client devices, such as one or more UEs 115. In some examples, the communications manager 1720 may manage communications with one or more other network entities 105, and may include a controller or scheduler for controlling communications with UEs 115 (such as in cooperation with the one or more other network devices). In some examples, the communications manager 1720 may support an X2 interface within an LTE/LTE-A wireless communications network technology to provide communication between network entities 105.

The communications manager 1720 may support wireless communication in accordance with examples as disclosed herein. For example, the communications manager 1720 is capable of, configured to, or operable to support a means for outputting first configuration information indicative of a set of parameters associated with an active BWP of a UE and, as part of the first configuration information, second configuration information indicative of a set of multiple subbands with different valid quantities of PRBs. The communications manager 1720 is capable of, configured to, or operable to support a means for outputting a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands. The communications manager 1720 is capable of, configured to, or operable to support a means for communicating the data message in accordance with the FDRA.

By including or configuring the communications manager 1720 in accordance with examples as described herein, the device 1705 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1720 may be configured to perform various operations (such as receiving, obtaining, monitoring, outputting, transmitting) using or otherwise in cooperation with the transceiver 1710, the one or more antennas 1715 (such as where applicable), or any combination thereof. Although the communications manager 1720 is illustrated as a separate component, in some examples, one or more functions described with reference to the communications manager 1720 may be supported by or performed by the transceiver 1710, one or more of the at least one processor 1735, one or more of the at least one memory 1725, the code 1730, or any combination thereof (for example, by a processing system including at least a portion of the at least one processor 1735, the at least one memory 1725, the code 1730, or any combination thereof). For example, the code 1730 may include instructions executable by one or more of the at least one processor 1735 to cause the device 1705 to perform various aspects of DCI designs with light adaptation between subbands of an active BWP as described herein, or the at least one processor 1735 and the at least one memory 1725 may be otherwise configured to, individually or collectively, perform or support such operations.

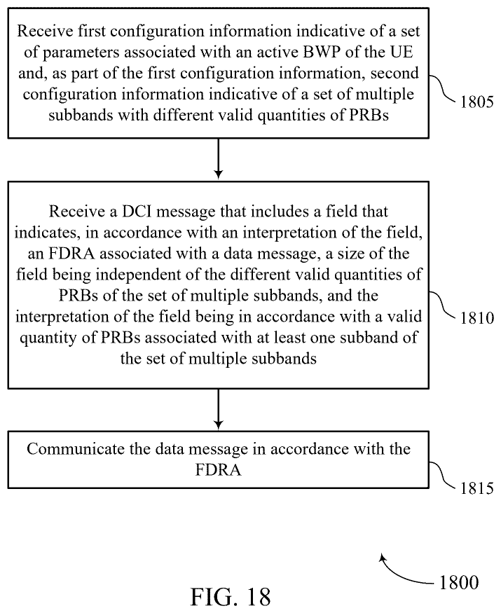

FIG. 18 shows a flowchart illustrating a method 1800 that supports DCI designs with light adaptation between subbands of an active BWP. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1805, the method may include receiving first configuration information indicative of a set of parameters associated with an active BWP of the UE and, as part of the first configuration information, second configuration information indicative of a set of multiple subbands with different valid quantities of PRBs. The operations of 1805 may be performed in accordance with examples as disclosed herein. In some examples, aspects of the operations of 1805 may be performed by a BWP configuration component 1225 as described with reference to FIG. 12.

At 1810, the method may include receiving a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands. The operations of 1810 may be performed in accordance with examples as disclosed herein. In some examples, aspects of the operations of 1810 may be performed by a DCI interpretation component 1230 as described with reference to FIG. 12.

At 1815, the method may include communicating the data message in accordance with the FDRA. The operations of 1815 may be performed in accordance with examples as disclosed herein. In some examples, aspects of the operations of 1815 may be performed by a data communication component 1235 as described with reference to FIG. 12.

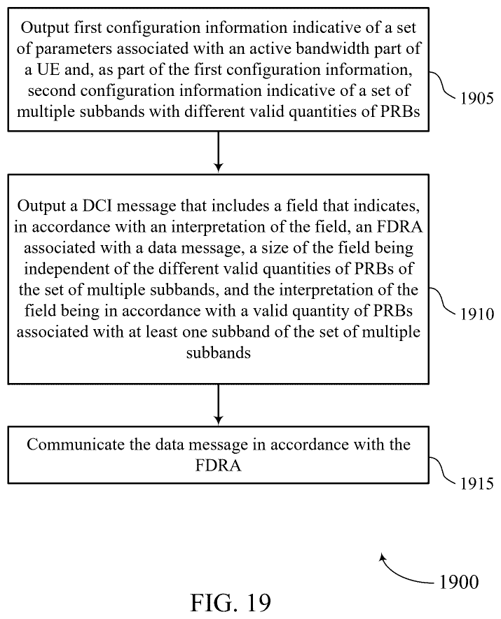

FIG. 19 shows a flowchart illustrating a method 1900 that supports DCI designs with light adaptation between subbands of an active BWP. The operations of the method 1900 may be implemented by a network entity or its components as described herein. For example, the operations of the method 1900 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 1905, the method may include outputting first configuration information indicative of a set of parameters associated with an active BWP of a UE and, as part of the first configuration information, second configuration information indicative of a set of multiple subbands with different valid quantities of PRBs. The operations of 1905 may be performed in accordance with examples as disclosed herein. In some examples, aspects of the operations of 1905 may be performed by a BWP configuration component 1625 as described with reference to FIG. 16.

At 1910, the method may include outputting a DCI message that includes a field that indicates, in accordance with an interpretation of the field, an FDRA associated with a data message, a size of the field being independent of the different valid quantities of PRBs of the set of multiple subbands, and the interpretation of the field being in accordance with a valid quantity of PRBs associated with at least one subband of the set of multiple subbands. The operations of 1910 may be performed in accordance with examples as disclosed herein. In some examples, aspects of the operations of 1910 may be performed by a DCI interpretation component 1630 as described with reference to FIG. 16.

At 1915, the method may include communicating the data message in accordance with the FDRA. The operations of 1915 may be performed in accordance with examples as disclosed herein. In some examples, aspects of the operations of 1915 may be performed by a data communication component 1635 as described with reference to FIG. 16.

The following provides an overview of aspects of the present disclosure:
Aspect 1: A method for wireless communication at a UE, including: receiving first configuration information indicative of a set of parameters associated with an active BWP of the UE and, as part of the first configuration information, second configuration information indicative of a plurality of subbands with different valid quantities of PRBs; receiving a DCI message that includes a field that indicates, in accordance with an interpretation of the field, an FDRA associated with a data message, a size of the field being independent of the different valid quantities of PRBs of the plurality of subbands, and the interpretation of the field being in accordance with a valid quantity of PRBs associated with at least one subband of the plurality of subbands within the active BWP; and communicating the data message in accordance with the FDRA.
Aspect 2: The method of aspect 1, where the plurality of subbands within the active BWP includes a first subband and a second subband, and the first subband includes a first valid quantity of PRBs and the second subband includes a second valid quantity of PRBs that is greater than the first valid quantity of PRBs.
Aspect 3: The method of aspect 2, where the interpretation of the field is a first interpretation in accordance with the UE being indicated, by the DCI message or a prior DCI message, to use the first subband that includes the first valid quantity of PRB; or is a second interpretation in accordance with the UE being indicated, by the DCI message or the prior DCI message, to use the second subband that includes the second valid quantity of PRBs.
Aspect 4: The method of aspect 3, where the field indicates a resource indication value from a set of resource indication values, and the UE expects a subset of resource indication values of the set of resource indication values as valid resource indication values in accordance with the first interpretation and expects the set of resource indication values as the valid resource indication values in accordance with the second interpretation.
Aspect 5: The method of any of aspects 3-4, where the field includes a set of bits, and the UE uses a subset of bits of the set of bits to obtain the FDRA in accordance with the first interpretation and uses the set of bits to obtain the FDRA in accordance with the second interpretation.
Aspect 6: The method of aspect 5, where the subset of bits is a subset of least significant bits or a subset of most significant bits of the set of bits.
Aspect 7: The method of any of aspects 3-6, where the field includes a plurality of bits, and the UE uses the plurality of bits to obtain the FDRA at a first RBG size in accordance with the first interpretation and uses the plurality of bits to obtain the FDRA at a second RBG size in accordance with the second interpretation.
Aspect 8: The method of any of aspects 3-7, where the DCI message or the prior DCI message includes a subband field indicative of a subband of the plurality of subbands within the active BWP, and the subband field indicates whether the UE is to use the first subband or the second subband.
Aspect 9: The method of any of aspects 3-8, where the DCI message includes a slot offset field indicative of a slot offset between the DCI message and the data message, and the UE is indicated to use the first subband that includes the first valid quantity of PRBs in accordance with the slot offset failing to satisfy a threshold slot offset or is indicated to use the second subband that includes the second valid quantity of PRBs in accordance with the slot offset satisfying the threshold slot offset.
Aspect 10: The method of any of aspects 2-9, where the first subband is associated with a scheduling restriction in accordance with the first subband including the first valid quantity of PRBs that is less than the second valid quantity of PRBs; and the second subband is associated with an absence of the scheduling restriction in accordance with the second subband including the second valid quantity of PRBs that is greater than the first valid quantity of PRBs.
Aspect 11: The method of aspect 10, where the scheduling restriction defines an expectation of the UE to not be allocated with frequency domain resources outside of the first subband within a threshold duration of a reception time of the DCI message in accordance with the UE operating at the first subband.
Aspect 12: The method of any of aspects 2-11, where the first subband is a subset of the second subband.
Aspect 13: The method of any of aspects 2-12, where the first valid quantity of PRBs defines a first set of one or more PRBs that are usable for scheduling within the first subband; and the second valid quantity of PRBs defines a second set of one or more PRBs that are usable for scheduling within the second subband.
Aspect 14: The method of any of aspects 1-13, where the size of the field that indicates the FDRA is constant across the plurality of subbands within the active BWP.
Aspect 15: The method of any of aspects 1-14, where the size of the field that indicates the FDRA is associated with a widest subband of the plurality of subbands within the active BWP.
Aspect 16: The method of any of aspects 1-15, where the set of parameters is associated with the active BWP and each subband of the plurality of subbands within the active BWP, and the set of parameters includes one or more of one or more first parameters associated with a CORESET; one or more second parameters associated with an SRS configuration; one or more third parameters associated with configured grant communications; and one or more fourth parameters associated with semi-persistently scheduled communications.
Aspect 17: The method of aspect 16, where the UE receives the DCI message via a set of downlink control channel resources associated with the CORESET.
Aspect 18: A method for wireless communication at a network entity, including: outputting first configuration information indicative of a set of parameters associated with an active BWP of a UE and, as part of the first configuration information, second configuration information indicative of a plurality of subbands with different valid quantities of PRBs; outputting a DCI message that includes a field that indicates, in accordance with an interpretation of the field, an FDRA associated with a data message, a size of the field being independent of the different valid quantities of PRBs of the plurality of subbands, and the interpretation of the field being in accordance with a valid quantity of PRBs associated with at least one subband of the plurality of subbands within the active BWP; and communicating the data message in accordance with the FDRA.
Aspect 19: The method of aspect 18, where the plurality of subbands within the active BWP includes a first subband and a second subband, and the first subband includes a first valid quantity of PRBs and the second subband includes a second valid quantity of PRBs that is greater than the first valid quantity of PRBs.
Aspect 20: The method of aspect 19, where the interpretation of the field is a first interpretation in accordance with the network entity indicating, by the DCI message or a prior DCI message, the UE to use the first subband that includes the first valid quantity of PRBs or is a second interpretation in accordance with the network entity indicating, by the DCI message or the prior DCI message, the UE to use the second subband that includes the second valid quantity of PRBs.
Aspect 21: The method of aspect 20, where the field indicates a resource indication value from a set of resource indication values, and the network entity uses a subset of resource indication values of the set of resource indication values as valid resource indication values in accordance with the first interpretation and uses the set of resource indication values as the valid resource indication values in accordance with the second interpretation.
Aspect 22: The method of any of aspects 20-21, where the field includes a set of bits, and the network entity uses a subset of bits of the set of bits to indicate the FDRA in accordance with the first interpretation and uses the set of bits to indicate the FDRA in accordance with the second interpretation.
Aspect 23: The method of aspect 22, where the subset of bits is a subset of least significant bits or a subset of most significant bits of the set of bits.
Aspect 24: The method of any of aspects 20-23, where the field includes a plurality of bits, and the network entity uses the plurality of bits to indicate the FDRA at a first RBG size in accordance with the first interpretation and uses the plurality of bits to indicate the FDRA at a second RBG size in accordance with the second interpretation.
Aspect 25: The method of any of aspects 20-24, where the DCI message or the prior DCI message includes a subband field indicative of a subband of the plurality of subbands within the active BWP, and the subband field indicates whether the UE is to use the first subband or the second subband.
Aspect 26: The method of any of aspects 20-25, where the DCI message includes a slot offset field indicative of a slot offset between the DCI message and the data message, and the network entity indicates the UE to use the first subband that includes the first valid quantity of PRBs in accordance with the slot offset failing to satisfy a threshold slot offset or to use the second subband that includes the second valid quantity of PRBs in accordance with the slot offset satisfying the threshold slot offset.
Aspect 27: The method of any of aspects 19-26, where the first subband is associated with a scheduling restriction in accordance with the first subband including the first valid quantity of PRBs that is less than the second valid quantity of PRBs; and the second subband is associated with an absence of the scheduling restriction in accordance with the second subband including the second valid quantity of PRBs that is greater than the first valid quantity of PRBs.
Aspect 28: The method of aspect 27, where the scheduling restriction defines an expectation of the network entity to not allocate the UE with frequency domain resources outside of the first subband within a threshold duration of a reception time of the DCI message in accordance with the UE operating at the first subband.
Aspect 29: The method of any of aspects 19-28, where the first subband is a subset of the second subband.
Aspect 30: The method of any of aspects 19-29, where the first valid quantity of PRBs defines a first set of one or more PRBs that are usable for scheduling within the first subband; and the second valid quantity of PRBs defines a second set of one or more PRBs that are usable for scheduling within the second subband.
Aspect 31: The method of any of aspects 18-30, where the size of the field that indicates the FDRA is constant across the plurality of subbands within the active BWP.
Aspect 32: The method of any of aspects 18-31, where the size of the field that indicates the FDRA is associated with a widest subband of the plurality of subbands within the active BWP.
Aspect 33: The method of any of aspects 18-32, where the set of parameters is associated with the active BWP and each subband of the plurality of subbands within the active BWP, and the set of parameters includes one or more of one or more first parameters associated with a CORESET; one or more second parameters associated with an SRS configuration; one or more third parameters associated with configured grant communications; and one or more fourth parameters associated with semi-persistently scheduled communications.
Aspect 34: The method of aspect 33, where the network entity outputs the DCI message via a set of downlink control channel resources associated with the CORESET.
Aspect 35: An apparatus for wireless communication at a UE, including a processing system that includes processor circuitry and memory circuitry that stores code, the processing system configured to cause the apparatus to perform a method of any of aspects 1-17.
Aspect 36: An apparatus for wireless communication at a UE, including at least one means for performing a method of any of aspects 1-17.
Aspect 37: A non-transitory computer-readable medium storing code for wireless communication, the code including instructions executable by a processing system to perform a method of any of aspects 1-17.
Aspect 38: An apparatus for wireless communication at a network entity, including a processing system that includes processor circuitry and memory circuitry that stores code, the processing system configured to cause the apparatus to perform a method of any of aspects 18-34.
Aspect 39: An apparatus for wireless communication at a network entity, including at least one means for performing a method of any of aspects 18-34.
Aspect 40: A non-transitory computer-readable medium storing code for wireless communication, the code including instructions executable by a processing system to perform a method of any of aspects 18-34.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (such as a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (such as a list of items prefaced by a phrase such as “at least one of” or “one or more of”) indicates an inclusive list such that, for example, a list of at least one of A, B, or C means A or B or C or AB or AC or BC or ABC (A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrases “based at least in part on,” “associated with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processing system that includes processor circuitry and memory circuitry that stores code, the processing system configured to cause the apparatus to:
receive first configuration information indicative of a set of parameters associated with an active bandwidth part of the UE and, as part of the first configuration information, second configuration information indicative of a plurality of subbands with different valid quantities of physical resource blocks;
receive a downlink control information message that comprises a field that indicates, in accordance with an interpretation of the field, a frequency domain resource allocation associated with a data message, a size of the field being independent of the different valid quantities of physical resource blocks of the plurality of subbands, and the interpretation of the field being in accordance with a valid quantity of physical resource blocks associated with at least one subband of the plurality of subbands; and
communicate the data message in accordance with the frequency domain resource allocation.

2. The apparatus of claim 1, wherein the plurality of subbands comprises a first subband and a second subband, and wherein:
the first subband comprises a first valid quantity of physical resource blocks; and
the second subband comprises a second valid quantity of physical resource blocks that is greater than the first valid quantity of physical resource blocks.

3. The apparatus of claim 2, wherein the interpretation of the field is:
a first interpretation in accordance with the UE being indicated, by the downlink control information message or a prior downlink control information message, to use the first subband that comprises the first valid quantity of physical resource blocks; or
a second interpretation in accordance with the UE being indicated, by the downlink control information message or the prior downlink control information message, to use the second subband that comprises the second valid quantity of physical resource blocks.

4. The apparatus of claim 3, wherein the field indicates a resource indication value from a set of resource indication values, and wherein the apparatus expects:
a subset of resource indication values of the set of resource indication values as valid resource indication values in accordance with the first interpretation; and
the set of resource indication values as the valid resource indication values in accordance with the second interpretation.

5. The apparatus of claim 3, wherein the field comprises a set of bits, and wherein the apparatus uses:
a subset of bits of the set of bits to obtain the frequency domain resource allocation in accordance with the first interpretation; and
uses the set of bits to obtain the frequency domain resource allocation in accordance with the second interpretation.

6. The apparatus of claim 3, wherein the field comprises a plurality of bits, and wherein the apparatus uses:
the plurality of bits to obtain the frequency domain resource allocation at a first resource block group size in accordance with the first interpretation; and
the plurality of bits to obtain the frequency domain resource allocation at a second resource block group size in accordance with the second interpretation.

7. The apparatus of claim 3, wherein:
the downlink control information message or the prior downlink control information message comprises a subband field indicative of a subband of the plurality of subbands within the active bandwidth part; and
the subband field indicates whether the UE is to use the first subband or the second subband.

8. The apparatus of claim 3, wherein the downlink control information message comprises a slot offset field indicative of a slot offset between the downlink control information message and the data message, and wherein the UE is indicated to use:
the first subband that comprises the first valid quantity of physical resource blocks in accordance with the slot offset failing to satisfy a threshold slot offset; or
the second subband that comprises the second valid quantity of physical resource blocks in accordance with the slot offset satisfying the threshold slot offset.

9. The apparatus of claim 2, wherein:
the first subband is associated with a scheduling restriction in accordance with the first subband comprising the first valid quantity of physical resource blocks that is less than the second valid quantity of physical resource blocks; and
the second subband is associated with an absence of the scheduling restriction in accordance with the second subband comprising the second valid quantity of physical resource blocks that is greater than the first valid quantity of physical resource blocks.

10. The apparatus of claim 9, wherein the scheduling restriction defines an expectation of the UE to not be allocated with frequency domain resources outside of the first subband within a threshold duration of a reception time of the downlink control information message in accordance with the UE operating at the first subband.

11. The apparatus of claim 2, wherein the first subband is a subset of the second subband.

12. The apparatus of claim 2, wherein:
the first valid quantity of physical resource blocks defines a first set of one or more physical resource blocks that are usable for scheduling within the first subband; and
the second valid quantity of physical resource blocks defines a second set of one or more physical resource blocks that are usable for scheduling within the second subband.

13. The apparatus of claim 1, wherein the size of the field that indicates the frequency domain resource allocation is associated with a widest subband of the plurality of subbands within the active bandwidth part.

14. The apparatus of claim 1, wherein the set of parameters is associated with the active bandwidth part and each subband of the plurality of subbands within the active bandwidth part, and wherein the set of parameters comprises one or more of:
one or more first parameters associated with a control resource set;
one or more second parameters associated with a sounding reference signal configuration;
one or more third parameters associated with configured grant communications; and
one or more fourth parameters associated with semi-persistently scheduled communications.

15. An apparatus for wireless communication at a network entity, comprising:
a processing system that includes processor circuitry and memory circuitry that stores code, the processing system configured to cause the apparatus to:
output first configuration information indicative of a set of parameters associated with an active bandwidth part of a user equipment (UE) and, as part of the first configuration information, second configuration information indicative of a plurality of subbands with different valid quantities of physical resource blocks;
output a downlink control information message that comprises a field that indicates, in accordance with an interpretation of the field, a frequency domain resource allocation associated with a data message, a size of the field being independent of the different valid quantities of physical resource blocks of the plurality of subbands, and the interpretation of the field being in accordance with a valid quantity of physical resource blocks associated with at least one subband of the plurality of subbands; and
communicate the data message in accordance with the frequency domain resource allocation.

16. The apparatus of claim 15, wherein the plurality of subbands comprises a first subband and a second subband, and wherein:
the first subband comprises a first valid quantity of physical resource blocks; and
the second subband comprises a second valid quantity of physical resource blocks that is greater than the first valid quantity of physical resource blocks.

17. The apparatus of claim 16, wherein the interpretation of the field is:
a first interpretation in accordance with the network entity indicating, by the downlink control information message or a prior downlink control information message, the UE to use the first subband that comprises the first valid quantity of physical resource blocks; or
a second interpretation in accordance with the network entity indicating, by the downlink control information message or the prior downlink control information message, the UE to use the second subband that comprises the second valid quantity of physical resource blocks.

18. The apparatus of claim 17, wherein the field indicates a resource indication value from a set of resource indication values, and wherein the apparatus uses:
a subset of resource indication values of the set of resource indication values as valid resource indication values in accordance with the first interpretation; and
the set of resource indication values as the valid resource indication values in accordance with the second interpretation.

19. The apparatus of claim 17, wherein the field comprises a set of bits, and wherein the apparatus uses:
a subset of bits of the set of bits to indicate the frequency domain resource allocation in accordance with the first interpretation; and
the set of bits to indicate the frequency domain resource allocation in accordance with the second interpretation.

20. The apparatus of claim 19, wherein the subset of bits is a subset of least significant bits or a subset of most significant bits of the set of bits.

21. The apparatus of claim 17, wherein the field comprises a plurality of bits, and wherein the apparatus uses:
the plurality of bits to indicate the frequency domain resource allocation at a first resource block group size in accordance with the first interpretation; and
the plurality of bits to indicate the frequency domain resource allocation at a second resource block group size in accordance with the second interpretation.

22. A method for wireless communication at a user equipment (UE), comprising:
receiving first configuration information indicative of a set of parameters associated with an active bandwidth part of the UE and, as part of the first configuration information, second configuration information indicative of a plurality of subbands with different valid quantities of physical resource blocks;
receiving a downlink control information message that comprises a field that indicates, in accordance with an interpretation of the field, a frequency domain resource allocation associated with a data message, a size of the field being independent of the different valid quantities of physical resource blocks of the plurality of subbands, and the interpretation of the field being in accordance with a valid quantity of physical resource blocks associated with at least one subband of the plurality of subbands; and
communicating the data message in accordance with the frequency domain resource allocation.

23. The method of claim 22, wherein the plurality of subbands comprises a first subband and a second subband, and wherein:
the first subband comprises a first valid quantity of physical resource blocks; and
the second subband comprises a second valid quantity of physical resource blocks that is greater than the first valid quantity of physical resource blocks.

24. The method of claim 23, wherein the interpretation of the field is:
a first interpretation in accordance with the UE being indicated, by the downlink control information message or a prior downlink control information message, to use the first subband that comprises the first valid quantity of physical resource blocks; or
a second interpretation in accordance with the UE being indicated, by the downlink control information message or the prior downlink control information message, to use the second subband that comprises the second valid quantity of physical resource blocks.

25. The method of claim 24, wherein the field indicates a resource indication value from a set of resource indication values, and wherein the UE expects:
a subset of resource indication values of the set of resource indication values as valid resource indication values in accordance with the first interpretation; and
the set of resource indication values as the valid resource indication values in accordance with the second interpretation.

26. The method of claim 24, wherein the field comprises a set of bits, and wherein the UE uses:
a subset of bits of the set of bits to obtain the frequency domain resource allocation in accordance with the first interpretation; and
the set of bits to obtain the frequency domain resource allocation in accordance with the second interpretation.

27. The method of claim 24, wherein the field comprises a plurality of bits, and wherein the UE uses:
the plurality of bits to obtain the frequency domain resource allocation at a first resource block group size in accordance with the first interpretation; and
the plurality of bits to obtain the frequency domain resource allocation at a second resource block group size in accordance with the second interpretation.

28. A method for wireless communication at a network entity, comprising:
outputting first configuration information indicative of a set of parameters associated with an active bandwidth part of a user equipment (UE) and, as part of the first configuration information, second configuration information indicative of a plurality of subbands with different valid quantities of physical resource blocks;
outputting a downlink control information message that comprises a field that indicates, in accordance with an interpretation of the field, a frequency domain resource allocation associated with a data message, a size of the field being independent of the different valid quantities of physical resource blocks of the plurality of subbands, and the interpretation of the field being in accordance with a valid quantity of physical resource blocks associated with at least one subband of the plurality of subbands; and
communicating the data message in accordance with the frequency domain resource allocation.

29. The method of claim 28, wherein the plurality of subbands comprises a first subband and a second subband, and wherein:
the first subband comprises a first valid quantity of physical resource blocks; and
the second subband comprises a second valid quantity of physical resource blocks that is greater than the first valid quantity of physical resource blocks.

30. The method of claim 29, wherein the interpretation of the field is:
a first interpretation in accordance with the network entity indicating, by the downlink control information message or a prior downlink control information message, the UE to use the first subband that comprises the first valid quantity of physical resource blocks; or
a second interpretation in accordance with the network entity indicating, by the downlink control information message or the prior downlink control information message, the UE to use the second subband that comprises the second valid quantity of physical resource blocks.
